(19) United States
(12) Patent Application Publication
(10) Pub. No.: US 2026/0095103 A1
(43) Pub. Date: Apr. 2, 2026

(54) BIDIRECTIONAL POWER CONVERTER

(71) Applicant: ACBEL POLYTECH INC., New Taipei City (TW)

(72) Inventor: Cheng-Yen YEH, New Taipei City (TW)

(73) Assignee: ACBEL POLYTECH INC., New Taipei City (TW)

(21) Appl. No.: 18/901,896

(22) Filed: Sep. 30, 2024

(51) Int. Cl. H02M 3/335; H02M 1/00

(52) U.S. Cl. CPC H02M 3/33584; H02M 1/0058; H02M 3/33573

(57) ABSTRACT

A bidirectional power converter has a dual active bridge (DAB) converter circuit and a power storage unit. The DAB converter circuit includes a primary bridge circuit, a secondary bridge circuit, a primary power storage element, and a transformer. The power storage element is connected to a primary coil or a secondary coil of the transformer in series. The power storage unit is connected to the primary coil or the secondary coil in parallel. The primary bridge circuit and the secondary bridge circuit are operated in a zero-voltage-switching (ZVS) zone, and an impedance value of the power storage unit corresponds to a size of the ZVS zone.

### BACKGROUND OF THE INVENTION

### 1. Field of the Invention

The present invention relates to a bidirectional power converter, especially a bidirectional power converter that reduces switching power loss.

### 2. Description of the Related Art

A bidirectional DC to DC converter is widely used for charging or discharging a power storage component, such as a battery. A Dual Active Bridge (DAB) converter has become a dominant topology of the bidirectional DC to DC converter in recent years for advantages such as symmetrical structure, zero-voltage-switching (ZVS) topology, bidirectional power transmission capability, electrical isolation, wide gain range, and high power density.

With reference to FIGS. 13A and 13B, FIG. 13A is a schematic circuit diagram of the DAB converter 5, and FIG. 13B is a characteristic curve diagram of an output power and a voltage gain of the DAB converter 5. A switching control method of the DAB converter 5 uses a phase shift control to control a direction and a total amount of power transmission by adjusting a phase difference between a primary bridge circuit 51 and a secondary bridge circuit 52, such that the primary bridge circuit 51 and the secondary bridge circuit 52 can perform a ZVS at zero voltage for reducing switching power loss. However, in the phase shift control, since an effect of the ZVS of the DAB converter 5 is mainly affected by switching frequency, voltage gain, and load condition, the DAB converter 5 needs to be controlled to operate in a ZVS zone Z to achieve the lowest switching power loss.

However, in FIG. 13B, the ZVS zone Z is defined by a maximum output power characteristic curve Z₀, a first output power and voltage gain characteristic curve Z₁ of the primary bridge circuit 51, and a second output power and voltage gain characteristic curve Z₂ of the secondary bridge circuit 52. The maximum output power characteristic curve Z₀ is a curve that will not be affected. In the second output power and voltage gain characteristic curve Z₂ of the secondary bridge circuit 52, when operated at the output power smaller than 1, the DAB converter 5 is unable to perform the ZVS. On the other hand, in the first output power and voltage gain characteristic curve Z₁ of the primary bridge circuit 51, when operated at the output power greater than 1, the DAB converter 5 is also unable to perform the ZVS. Namely, effectiveness of the ZVS achieved by the DAB converter 5 is limited by a size of the ZVS zone Z.

Therefore, a conventional bidirectional power converter needs to be improved.

### SUMMARY OF THE INVENTION

The present invention provides a bidirectional power converter. One embodiment of the bidirectional power converter includes a dual active bridge (DAB) converter circuit and a primary power storage unit. The DAB converter circuit includes a primary bridge circuit, a secondary bridge circuit, a primary power storage element, and a transformer. A first end and a second end of the primary bridge circuit are respectively electrically connected to a first signal end and the primary power storage element. The primary power storage element is electrically connected to a primary coil of the transformer in series. A first end and a second end of the secondary bridge circuit are respectively electrically connected to a secondary coil of the transformer and a second signal end. The primary power storage unit has a first impedance value, and is electrically connected to the primary coil of the transformer in parallel. The primary power storage unit stores power when charging or discharging the primary and secondary bridge circuits. The primary and secondary bridge circuits are operated in a zero-voltage-switching (ZVS) zone defined by a maximum output power characteristic curve, a first output power and voltage gain characteristic curve of the primary bridge circuit, and a second output power and voltage gain characteristic curve of the secondary bridge circuit to reduce a switching power loss. The first output power and voltage gain characteristic curve of the primary bridge circuit is a curve with a voltage gain greater than or equal to 1, and the second output power and voltage gain characteristic curve of the secondary bridge circuit is a curve with a voltage gain smaller than or equal to 1. An amount of power stored in the primary power storage unit corresponds to the first impedance value of the primary power storage unit, and the first impedance value of the primary power storage unit corresponds to a size of the ZVS zone.

The present invention provides a bidirectional power converter. Another embodiment of the bidirectional power converter includes a DAB converter circuit and a secondary power storage unit. The DAB converter circuit includes a primary bridge circuit, a secondary bridge circuit, a secondary power storage element, and a transformer. A first end and a second end of the primary bridge circuit are respectively electrically connected to a first signal end and a primary coil of the transformer. The secondary power storage element is electrically connected to a secondary coil of the transformer in series. A first end and a second end of the secondary bridge circuit are respectively electrically connected to the secondary power storage element and a second signal end. The secondary power storage unit has a second impedance value, is electrically connected to the secondary coil of the transformer in parallel, and stores power when charging or discharging the primary bridge circuit and the secondary bridge circuit. The primary and secondary bridge circuits are operated in a zero-voltage-switching (ZVS) zone defined by a maximum output power characteristic curve, a first output power and voltage gain characteristic curve of the primary bridge circuit, and a second output power and voltage gain characteristic curve of the secondary bridge circuit to reduce a switching power loss. The first output power and voltage gain characteristic curve of the primary bridge circuit is a curve with a voltage gain greater than or equal to 1, and the second output power and voltage gain characteristic curve of the secondary bridge circuit is a curve with a voltage gain smaller than or equal to 1. An amount of power stored in the secondary power storage unit corresponds to the second impedance value of the secondary power storage unit, and the second impedance value corresponds to a size of the ZVS zone.

Since the bidirectional power converter includes the primary power storage unit or the secondary power storage unit, the DAB converter circuit can be operated in a wide voltage gain range to perform ZVS, such that the switching power loss can be reduced for increasing applications of the bidirectional power converter.

### BRIEF DESCRIPTION OF THE DRAWINGS

FIG. 1A is a schematic circuit diagram of a bidirectional power converter of the present invention.

FIG. 1B is a normalized power and voltage gain characteristic curve diagram.

FIG. 2A is a schematic analysis diagram of a π-type inductor circuit.

FIG. 2B is a schematic analysis diagram of a normalized π-type inductor circuit.

FIG. 2C is a schematic diagram of a primary voltage gain curve, a secondary voltage gain curve, an inductor current leading phase waveform curve, and an inductor current lagging phase waveform curve after normalizing the π-type inductor circuit shown in FIG. 2A.

FIGS. 3A to 3C are schematic diagrams of embodiments of a primary power storage unit of the bidirectional power converter of the present invention.

FIGS. 4A to 4C are schematic diagrams of embodiments of a primary power storage component.

FIGS. 5A to 5C are schematic diagrams of embodiments of a secondary power storage unit of the bidirectional power converter of the present invention.

FIGS. 6A to 6C are schematic diagrams of embodiments of a secondary power storage component.

FIG. 7 is a schematic boundary power and load distribution diagram of a ZVS range of an original normalized charging mode.

FIG. 8 is a schematic boundary power and load distribution diagram of a ZVS range of an original normalized discharging mode.

FIGS. 9 and 10 are schematic ZVS diagrams of a primary first inductor and a primary second inductor.

FIGS. 11 and 12 are schematic diagrams of actual ZVS boundary power change and load curves after restoring a normalization.

FIG. 13A is a schematic circuit diagram of a conventional DAB converter.

FIG. 13B is an output power and voltage gain characteristic curve diagram of the conventional DAB converter.

### DETAILED DESCRIPTION OF THE INVENTION

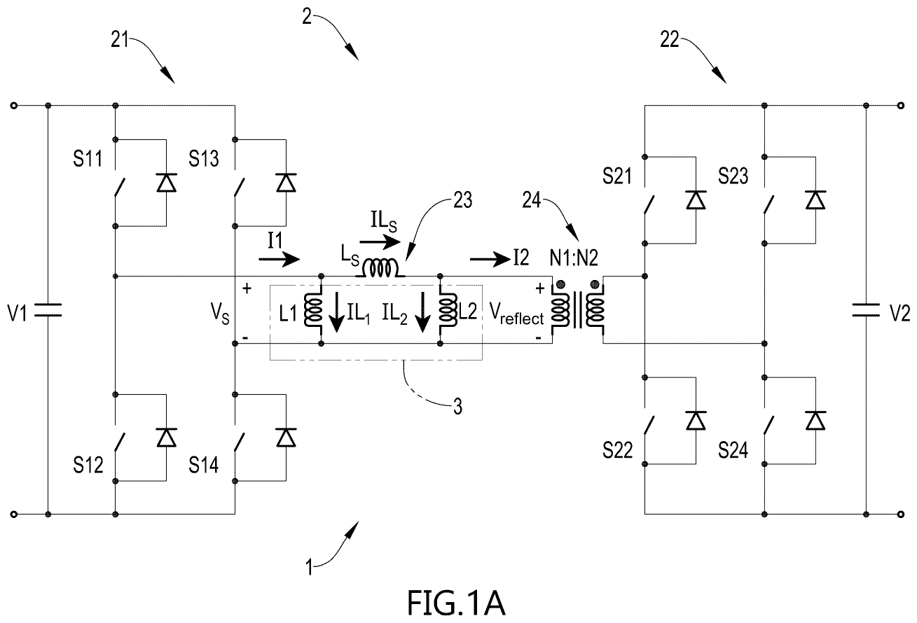

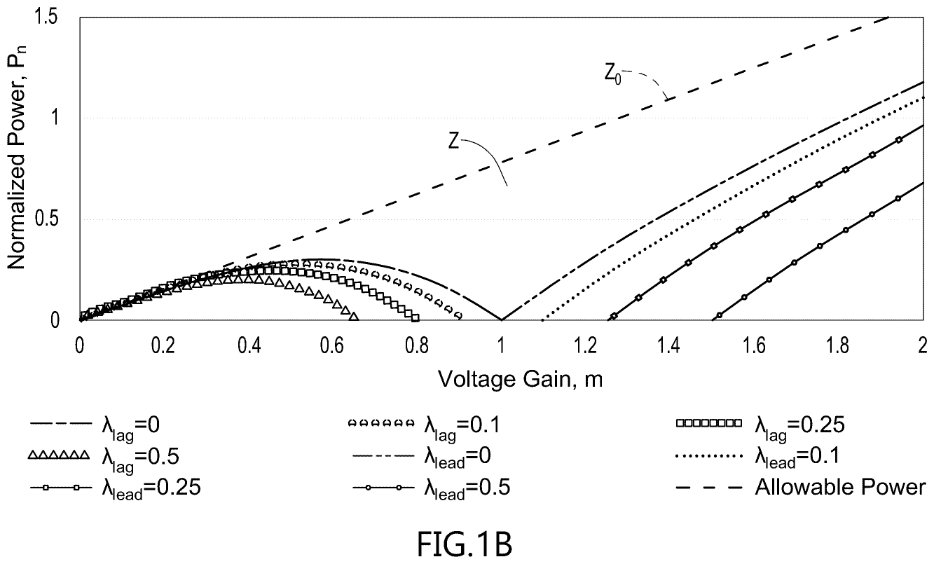

With reference to FIGS. 1A and 1B, FIG. 1A is a schematic circuit diagram of a bidirectional power converter 1 of the present invention, and FIG. 1B is a normalized power and voltage gain characteristic curve diagram. The bidirectional power converter 1 includes a dual active bridge (DAB) converter circuit 2 and a primary power storage unit 3. The DAB converter circuit 2 includes a primary bridge circuit 21, a secondary bridge circuit 22, a primary power storage element 23, and a transformer 24. The primary bridge circuit 21 includes a first switch S11, a second switch S12, a third switch S13, and a fourth switch S14. A first end and a second end of the primary bridge circuit 21 are respectively electrically connected to a first signal end V1 and the primary power storage element 23. The primary power storage element 23 is electrically connected to a primary coil N1 of the transformer 24 in series. The secondary bridge circuit 22 includes a first switch S21, a second switch S22, a third switch S23, and a fourth switch S24. A first end and a second end of the secondary bridge circuit 22 are respectively electrically connected to a secondary coil N2 of the transformer and a second signal end V2. The primary power storage unit 3 has a first impedance value, is electrically connected to the primary coil N1 of the transformer 24 in parallel, and stores power when charging or discharging the primary bridge circuit 21 and the secondary bridge circuit 22. The primary and secondary bridge circuits 21, 22 are operated in a zero-voltage-switching (ZVS) zone Z defined by a maximum output power characteristic curve Z₀, a first output power and voltage gain characteristic curve of the primary bridge circuit 21, and a second output power and voltage gain characteristic curve of the secondary bridge circuit 22 to reduce a switching power loss. The first output power and voltage gain characteristic curve of the primary bridge circuit 21 is one of curves of “λ_{lead}=0, λ_{lead}=0.1, λ_{lead}=0.25, λ_{lead}=0.5”, and the second output power and voltage gain characteristic curve of the secondary bridge circuit 22 is one of curves of “λ_{lag}=0, λ_{lag}=0.1, λ_{lag}=0.25, λ_{lag}=0.5”. The maximum output power characteristic curve Z₀ is a curve of “Allowable power”. The first output power and voltage gain characteristic curve of the primary bridge circuit 21 is a curve with a voltage gain m greater than or equal to 1, and the second output power and voltage gain characteristic curve of the secondary bridge circuit 22 is a curve with a voltage gain m smaller than or equal to 1. An amount of power stored in the primary power storage unit 3 corresponds to the first impedance value of the primary power storage unit 3, and the first impedance value corresponds to a size of the ZVS zone. Therefore, FIG. 1B shows multiple first output power and voltage gain characteristic curves of the primary bridge circuit 21, such as the curves of “λ_{lead}=0, λ_{lead}=0.1, λ_{lead}=0.25, λ_{lead}=0.5”, and multiple second output power and voltage gain characteristic curves of the secondary bridge circuit 22, such as the curves of “λ_{lag}=0, λ_{lag}=0.1, λ_{lag}=0.25, λ_{lag}=0.5”, corresponding to different impedance values. In an embodiment of the present invention, the first switch S11, the second switch S12, the third switch S13, and the fourth switch S14 of the primary bridge circuit 21, and the first switch S21, the second switch S22, the third switch S23, and the fourth switch S24 of the secondary bridge circuit can be various semiconductor switches, such as metal oxide semiconductor field effect transistor (MOSFET), but not limited thereto.

In FIG. 1A, the primary power storage unit 3 includes a primary first inductor L1 disposed between the second end of the primary bridge circuit 21 and the primary power storage element 23. In FIG. 1B, the smaller an impedance value of the primary first inductor L1, the greater a size of the ZVS zone Z defined by the first output power and voltage gain characteristic curve of the primary bridge circuit 21. The greater the impedance value of the primary first inductor L1, the smaller the size of the ZVS zone Z defined by the first output power and voltage gain characteristic curve of the primary bridge circuit 21. A relation between the impedance value of the primary first inductor L1 and the size of the ZVS zone Z will be described in detail as follows.

In FIG. 1A, the primary power storage unit 3 includes a primary second inductor L2 disposed between the primary power storage element 23 and the primary coil N1 of the transformer 24. In FIG. 1B, the smaller an impedance value of the primary second inductor L2, the greater a size of the ZVS zone Z defined by the second output power and voltage gain characteristic curve of the secondary bridge circuit 22. The greater the impedance value of the primary second inductor L2, the smaller the size of the ZVS zone Z defined by the second output power and voltage gain characteristic curve of the secondary bridge circuit 22. A relation between the impedance value of the primary second inductor L2 and the size of the ZVS zone Z will be described in detail as follows.

In FIG. 1A, the primary power storage unit 3 may simultaneously include the primary first inductor L1 and the primary second inductor L2. The primary first inductor L1 is disposed between the second end of the primary bridge circuit 21 and the primary power storage element 23, and the primary second inductor L2 is disposed between the primary power storage element 23 and the primary coil N1 of the transformer 24. In FIG. 1B, the smaller the impedance value of the primary first inductor L1, the greater the size of the ZVS zone Z defined by the first output power and voltage gain characteristic curve of the primary bridge circuit 21. The greater the impedance value of the primary first inductor L1, the smaller the size of the ZVS zone Z defined by the first output power and voltage gain characteristic curve of the primary bridge circuit 21. Further, the smaller the impedance value of the primary second inductor L2, the greater the size of the ZVS zone Z defined by the second output power and voltage gain characteristic curve of the secondary bridge circuit 22. The greater the impedance value of the primary second inductor L2, the smaller the size of the ZVS zone Z defined by the second output power and voltage gain characteristic curve of the secondary bridge circuit 22. Similarly, the relation between the impedance value of the primary second inductor L2 and the size of the ZVS zone Z and the relation between the impedance value of the primary second inductor L2 and the size of the ZVS zone Z both will be described in detail as follows. Moreover, electrically connected to the primary coil N1 of the transformer 24 in parallel, the primary second inductor L2 can be integrated into the transformer 24, that is, implemented by a magnetizing inductor of the transformer 24, such that a number of components of the bidirectional power converter 1 can be further reduced.

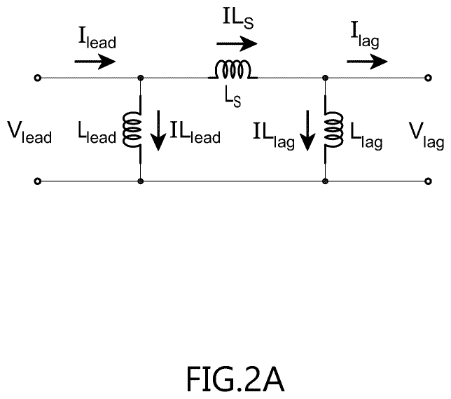

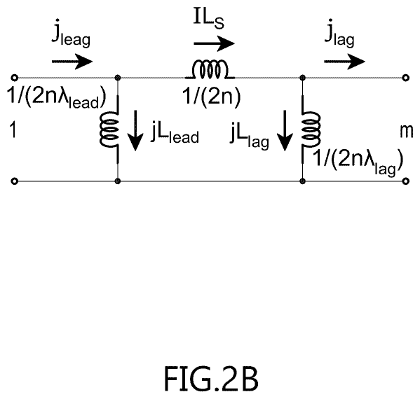

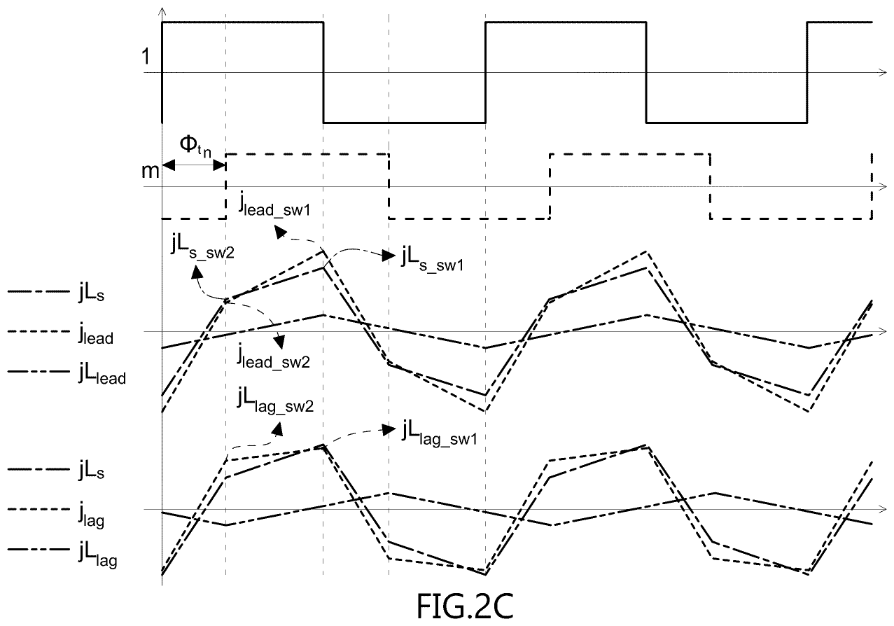

With reference to FIGS. 2A and 2B, FIG. 2A is a schematic analysis diagram of a π-type inductor circuit, and FIG. 2B is a schematic analysis diagram of a normalized π-type inductor circuit. In a real circuit structure, since different component parameters will induce different output power and voltage gain characteristic curves, a normalization algorithm is widely used in the engineering field to generate a normalized output power and voltage gain characteristic curve, which is restorable, such that the original output power and voltage gain characteristic curve can be obtained. Moreover, the normalization algorithm is adopted to generate the size of the ZVS zone Z defined by the maximum output power characteristic curve Z₀, the first output power and voltage gain characteristic curve of the primary bridge circuit 21, and the second output power and voltage gain characteristic curve of the secondary bridge circuit 22 in a charging mode and a discharging mode of the primary bridge circuit 21, the secondary bridge circuit 22, and the primary power storage unit 3. Further, the first impedance value of the primary power storage unit 3 is also generated by the normalization algorithm.

Regarding the normalization algorithm, in the bidirectional power converter of the present invention, firstly, the π-type inductor circuit formed by the primary first inductor L1, the primary power storage element 23, and the primary second inductor L2 is analyzed. Secondly, a voltage Vₛ across the primary first inductor L1, a primary coil voltage V_{reflect} of the transformer 24, a primary first current I1, a primary second current I2, a primary power storage element current ILₛ, a primary first inductor current IL₁, and a primary second inductor current IL₂ shown in FIG. 1A are renamed in FIG. 2A. The primary first inductor L1, the primary second inductor L2, and the primary power storage element 23 are renamed according to phase difference relations. For example, the primary first inductor L1 is renamed as a leading phase inductor L_{lead}, the primary second inductor L2 is renamed as a lagging phase inductor L_{lag}, and the primary power storage element 23 is renamed as a power storage inductor Lₛ. The subscript “lead” represents a leading phase, such as a leading phase voltage V_{lead}, a leading phase inductor current IL_{lead}, and a leading phase first current I_{lead}. The subscript “lag” represents a lagging phase, such as a lagging phase voltage V_{lag}, a lagging phase inductor current IL_{lag}, and a lagging phase second current I_{lag}. In FIG. 1A, the first and second signal ends V1, V2 are not in a fixed relation, which is determined by phase relations of voltages on two ends. In addition, since the bidirectional power converter 1 is a bidirectional power flow application, an analysis of the π-type inductor circuit facilitates calculations of different power flow directions.

To simplify the design and analysis, a circuit is normalized for analyzing, and normalizations are selected as follows:

$$base voltage : {V}_{B} = {V}_{lead} ;$$

$$base angular frequency : {ω}_{B} = {F}_{s} {w}_{typ} ;$$

$$base frequency : {F}_{B} = {ω}_{B} ;$$

$$base time : {t}_{B} = \frac{1}{{F}_{B}} ;$$

$$base inductor value : {L}_{B} = 2 π {L}_{s} ;$$

$$base impedance value : {Z}_{B} = {ω}_{B} {L}_{B} ;$$

$$base current : {I}_{B} = \frac{{V}_{B}}{{Z}_{B}} ;$$

$$base power : {P}_{B} = \frac{{V}_{B}^{2}}{{Z}_{B}} ;$$

$$voltage gain : m = \frac{{V}_{lag}}{{V}_{B}} ;$$

$${λ}_{lead} = \frac{{L}_{s}}{{L}_{l e a d}} ;$$

$${λ}_{lag} = \frac{{L}_{s}}{{L}_{lag}} ;$$

Since the power flow direction of the bidirectional power converter is from a voltage leading phase to a voltage lagging phase, a leading phase voltage V_{lead} is used as the base voltage V_{B}. When the power flow direction is changed, the base voltage V_{B} can be accordingly changed.

With reference to FIGS. 2A to 2C, FIG. 2C is a schematic diagram of a primary voltage gain curve, a secondary voltage gain curve, an inductor current leading phase waveform curve, and an inductor current lagging phase waveform curve after normalizing the π-type inductor circuit shown in FIG. 2A. A phase difference is represented as Øtₙ, a symbol “j” is added into current symbols in FIGS. 2A and 2B for indicating a meaning of the normalization. According to the above-mentioned normalizations of λ_{lead} and λ_{lag}, when the normalization of the power storage inductor Lₛ is 1/2n, a relation between the normalized leading phase inductor L_{lead} and the normalized power storage inductor Lₛ is

$$\frac{1}{2 n {λ}_{l e a d}} ,$$

and a relation between the normalized lagging phase inductor L_{lag} and the normalized power storage inductor Lₛ is

$$\frac{1}{2 n {λ}_{lag}} .$$

Further with reference to FIG. 2C, a normalized total current j_{lead} is the leading phase first current I_{lead}, a normalized first current jLₛ is the primary power storage current ILₛ, and a normalized second current jL_{lead} is the leading phase inductor current IL_{lead}. The leading phase first current I_{lead} outputted from the primary bridge circuit 21 of the bidirectional power converter 1 to the primary power storage element 23 is equal to the primary power storage current ILₛ of the primary power storage element 23 plus the leading phase inductor current IL_{lead} flowing through the primary first inductor L1. Since the primary first inductor L1 can store power when the primary bridge circuit 21 is charging or discharging, the size of the ZVS zone Z can be adjusted according to the power stored in the primary first inductor L1. Detailed calculation formulas for FIG. 2C is as follows.

$$γ := \frac{π}{{f}_{n}} ; {f}_{n} = \frac{{F}_{Op}}{{F}_{B}} ; \qquad Formula ( 1 )$$

γ is a half switching cycle angle, and fₙ is a normalized operation frequency.

$$j {L}_{l ead} \_PK ( γ , {λ}_{l e a d} ) := \frac{1}{2} γ \cdot {λ}_{l e a d} ; {jL}_{l ead} \_PK ( γ , {λ}_{l e a d} ) \qquad Formula ( 2 )$$

is a leading phase inductor peak current.

$${jL}_{lag} \_PK ( γ , m , {λ}_{l a g} ) := \frac{1}{2} m \cdot γ \cdot {λ}_{l a g} ; {L}_{lag} \_PK ( γ , m , {λ}_{l a g} ) \qquad Formula ( 3 )$$

is a lagging phase inductor peak current.

Formula (4): j_{lead}_AV(γ, m, φ):=2γ·m·φ·(1−2φ); j_{lead}_AV(γ, m, φ) is a leading phase average input current.

Formula (5): p_{lead}(γ, m, φ):=j_{lead}_AV(γ, m, φ); p_{lead}(γ, m, φ) is an input power.

Formula (6): jₒ(γ, φ):=2γ·φ·(1−2φ); jₒ(γ, φ) is a lagging phase average output current.

$${j}_{lead \_ sw 1 \_ j} ( γ , m , j , {λ}_{l e a d} ) := \frac{1}{2} γ \cdot [ ( 1 + {λ}_{l e a d} ) - m \cdot \sqrt{1 - \frac{4 \cdot j}{γ}} ] ; \qquad Formula ( 7 )$$

j_{lead_sw1_j}(γ, m, j, λ_{lead}) is a leading phase sw1 switching current.

$${j}_{lead \_ sw 2 \_ j} ( γ , m , j , {λ}_{l e a d} ) := \frac{1}{2} γ \cdot [ m - ( 1 + {λ}_{l e a d} ) \cdot \sqrt{1 - \frac{4 \cdot j}{γ}} ] ; \qquad Formula ( 8 )$$

j_{lead_sw2_j}(γ, m, j, λ_{lead}) is a leading phase sw2 switching current.

$${j}_{lag \_ sw 1 \_ j} ( γ , m , j , {λ}_{l a g} ) := \frac{1}{2} γ \cdot [ 1 - m \cdot ( 1 + {λ}_{l e a d} ) \cdot \sqrt{1 - \frac{4 \cdot j}{γ}} ] ; \qquad Formula ( 9 )$$

j_{lag_sw1_j}(γ, m, j, λ_{lag}) is a lagging phase sw1 switching current.

$${j}_{lag \_ sw 2 \_ j} ( γ , m , j , {λ}_{l a g} ) := \frac{1}{2} γ \cdot [ m \cdot ( 1 + {λ}_{l e a d} ) - \sqrt{1 - \frac{4 \cdot j}{γ}} ] ; \qquad Formula ( 10 )$$

j_{lag_sw2_j}(γ, m, j, λ_{lag}) is a lagging phase sw2 switching current.

$${p}_{lead \_ ZVS} ( γ , m , {λ}_{lead} ) := \frac{1}{4} γ \cdot m \cdot [ 1 - {( \frac{1 + {λ}_{l e a d}}{m} )}^{2} ] ; \qquad Formula ( 11 )$$

p_{lead_ZVS}(γ, m, λ_{lead}) is a leading phase ZVS boundary power.

$${p}_{lag \_ ZVS} ( γ , m , {λ}_{l a g} ) := \frac{1}{4} γ \cdot m \cdot \{ 1 - {[ m \cdot ( 1 + {λ}_{l e a d} ) ]}^{2} \} ; \qquad Formula ( 12 )$$

p_{lag_ZVS}(γ, m, λ_{lag}) is a lagging phase ZVS boundary power.

$${p}_{max} ( γ , m ) := \frac{1}{4} γ \cdot m ; \qquad Formula ( 13 )$$

pₘₐₓ(γ, m) is the maximum output power.

According to Formula (11), Formula (12), and Formula (13), the primary first inductor L1 and the primary second inductor L2 do not affect each other, and do not affect the primary power storage current ILₛ of the primary power storage element 23 under any operation conditions. In addition, with reference to FIG. 2C and Formula (1) to Formula (13), a function of the leading phase inductor L_{lead} corresponding to the primary first inductor L1 is to adjust a current waveform of the leading phase first current I_{lead}, so that a leading phase bridge circuit has larger current during switching to perform ZVS. Further, the leading phase inductor L_{lead} has no effect on other portion of the circuit. Similarly, a function of the lagging phase inductor L_{lag} corresponding to the primary second inductor L2 is to adjust a current waveform of the lagging phase second current I_{lag}, so that a lagging phase bridge circuit has larger current during switching to perform ZVS. Further, the lagging phase inductor L_{lag} has no effect on other portion of the circuit. In other words, since the functions of the leading phase inductor L_{lead} and the lagging phase inductor L_{lag} are independent, that is, functions of the primary first inductor L1 and the primary second inductor L2 are independent, the leading phase inductor Lead and the lagging phase inductor L_{lag} do not affect each other, so that the leading phase inductor L_{lead} and the lagging phase inductor L_{lag} can each be independently adjusted and selected according to conditions, thereby making the bidirectional power converter 1 of the present invention more flexible in design and use.

With reference to FIG. 1B, and

$$γ := \frac{π}{{f}_{n}} , \qquad Formula ( 1 )$$

when fₙ=1, change curves of a normalized boundary power are as shown in FIG. 1B. A change curve of p_{lag_ZVS}(γ, m, λ_{lag}) of Formula (12) is corresponding to a characteristic curve whose voltage gain is smaller than or equal to 1. A change curve of p_{lead_ZVS}(γ, m, λ_{lead}) of Formula (11) is corresponding to a characteristic curve whose voltage gain is greater than or equal to 1. λ_{lead}=0 and λ_{lag}=0 correspond to a condition without the primary power storage unit 3. pₘₐₓ(γ, m) of Formula (13) corresponds to

$${p}_{max} = \frac{1}{4} π m .$$

According to p_{lag_ZVS}(γ, m, λ_{lag}) of Formula (12), in FIG. 1B, when an inductance of the lagging phase inductor L_{lag} is smaller, the λ_{lag} is greater, and a boundary of the second output power and voltage gain characteristic curve of the secondary bridge circuit 22 will move in the direction toward smaller voltage gain m. When an inductance of the leading phase inductor L_{lead} is smaller, the λ_{lead} is greater, and a boundary of the first output power and voltage gain characteristic curve of the primary bridge circuit 21 will move in the direction toward greater voltage gain m. Namely, when the inductance of the lagging phase inductor L_{lag} and the inductance of the leading phase inductor L_{lead} are both decreased, the size of the ZVS zone Z defined by the maximum output power characteristic curve Z₀, the first output power and voltage gain characteristic curve of the primary bridge circuit 21, and the second output power and voltage gain characteristic curve of the secondary bridge circuit 22 can be increased. Therefore, when charging or discharging the bridge circuits of the bidirectional power converter 1, the ZVS can be performed in a larger ZVS zone for improving an effect of the ZVS.

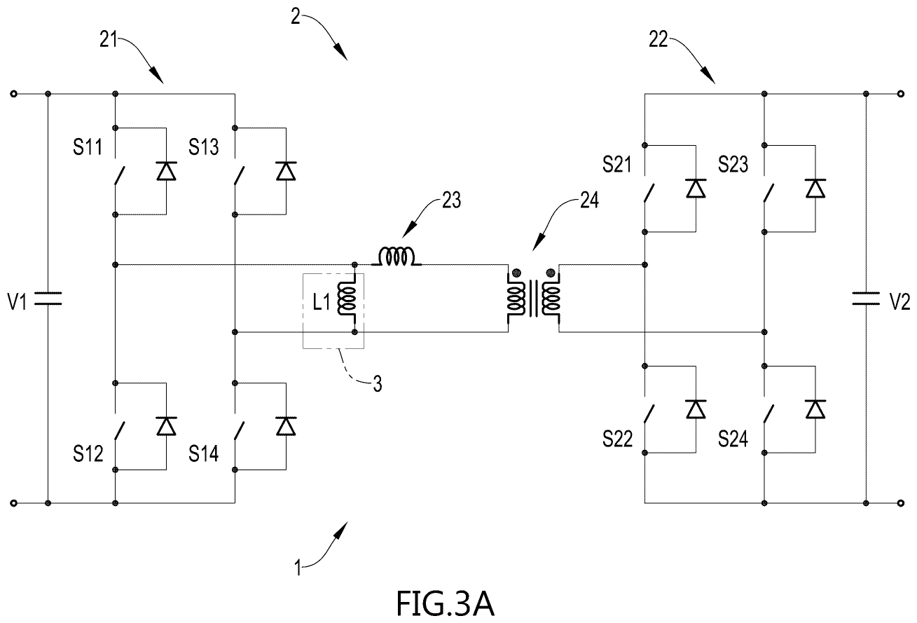

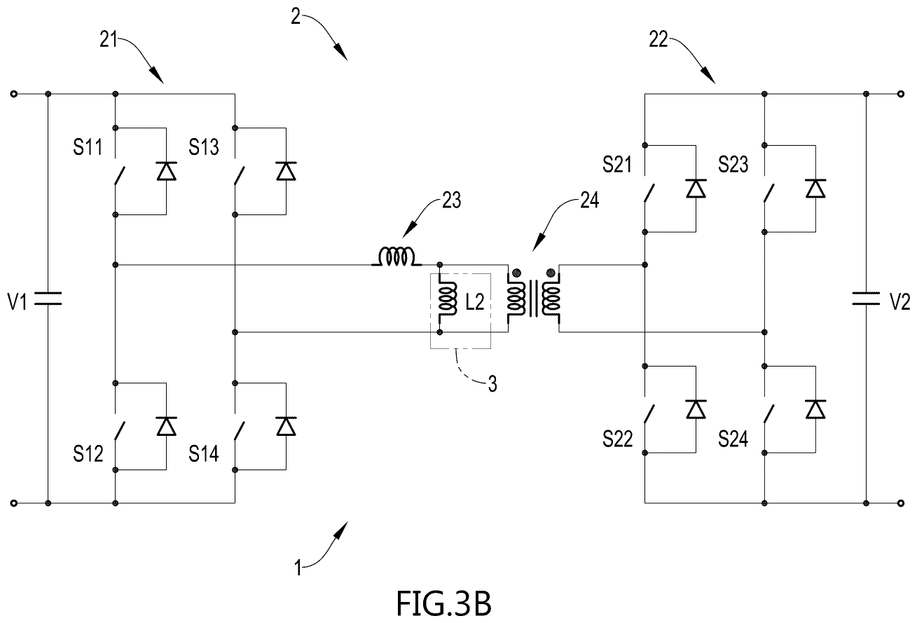

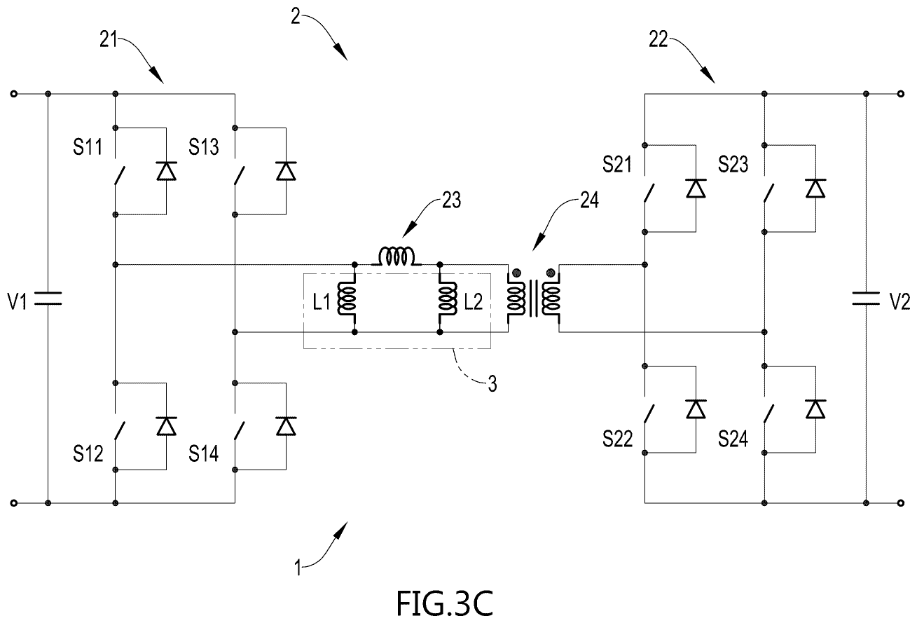

Please refer to FIGS. 3A to 3C, which are schematic diagrams of embodiments of a primary power storage unit of the bidirectional power converter 1 of the present invention. According to Formula (11) and Formula (12), when the primary first inductor L1 is disposed in the primary power storage unit 3 as shown in FIG. 3A, when the primary second inductor L2 is disposed in the primary power storage unit 3 as shown in FIG. 3B, or when the primary first inductor L1 and the primary second inductor L2 are both disposed in the primary power storage unit 3 as shown in FIG. 3B, the size of the ZVS zone Z can be increased through additional power stored in the primary power storage unit 3 when the primary bridge circuit 21 is charging or discharging.

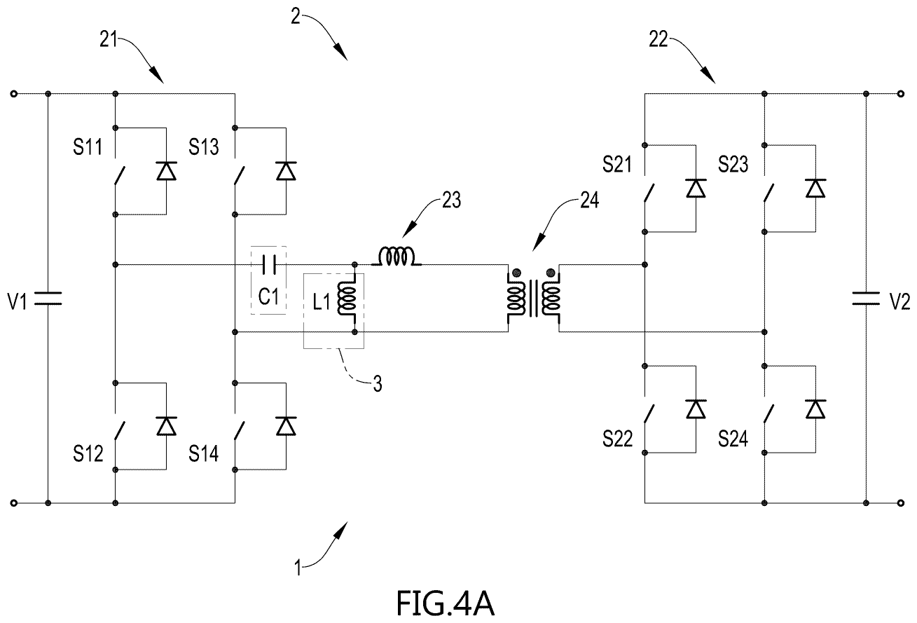

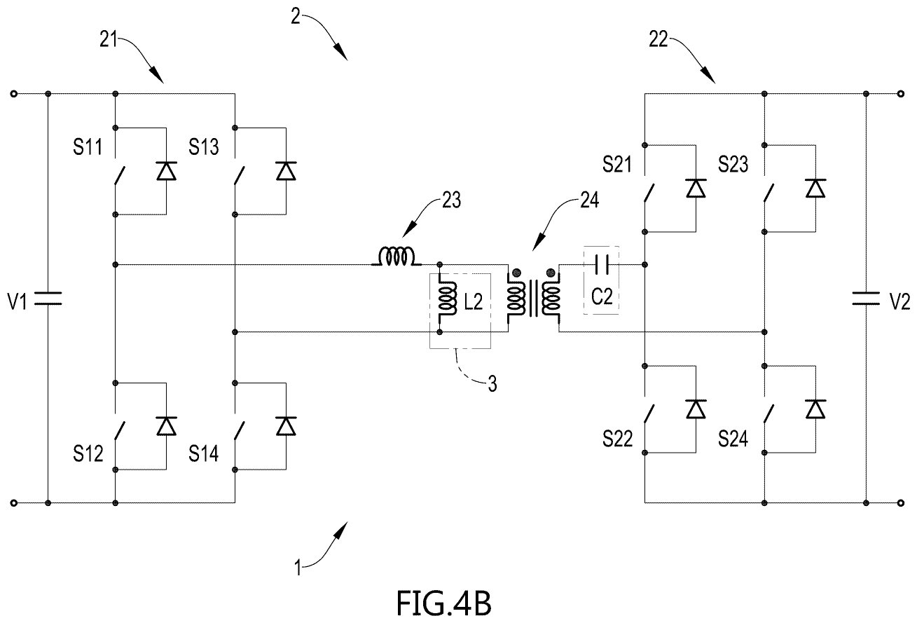

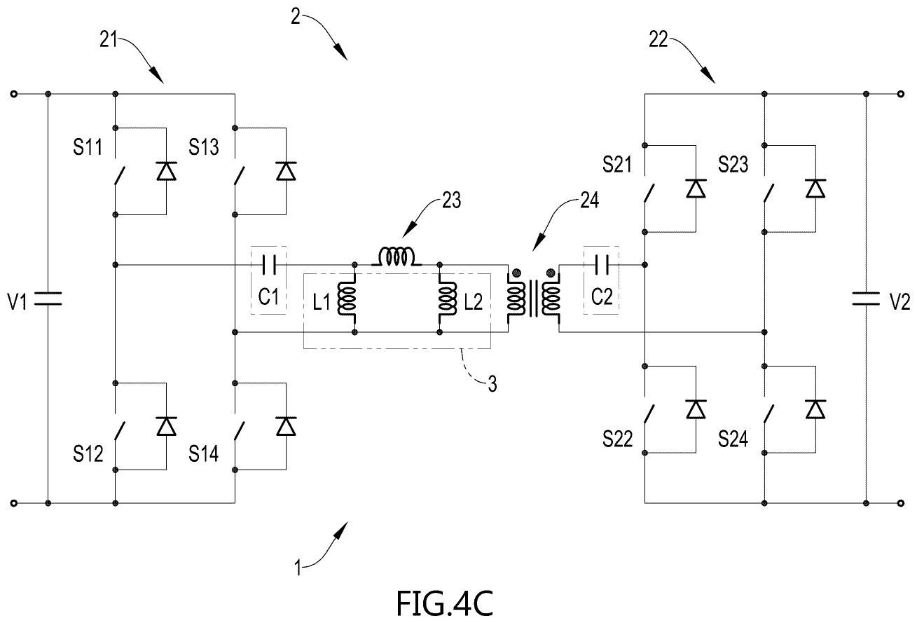

Please refer to FIGS. 4A to 4C, which are schematic diagrams of embodiments of the primary power storage component C1. Similarly, since the size of the ZVS zone Z can be increased through the additional power, in FIG. 4A, the bidirectional power converter 1 includes a primary power storage component C1. The primary power storage component C1 is electrically connected between the second end of the primary bridge circuit 21 and the primary power storage element 23 in series, and can store power when charging or discharging the primary bridge circuit 21 and the secondary bridge circuit 22. In the embodiment, the primary power storage component C1 includes a primary capacitor having a primary capacitance. The greater the primary capacitance, the greater the size of the ZVS zone Z defined by the first output power and voltage gain characteristic curve of the primary bridge circuit 21. The smaller the primary capacitance, the smaller the size of the ZVS zone Z defined by the first output power and voltage gain characteristic curve of the primary bridge circuit 21.

In an embodiment shown in FIG. 4B, the bidirectional power converter 1 includes a secondary power storage component C2. The secondary power storage component C2 is electrically connected between the first end of the secondary bridge circuit 22 and the secondary coil N2 of the transformer 24 in series, and the secondary power storage component C2 can store power when charging or discharging the primary bridge circuit 21 and the secondary bridge circuit 22. In this embodiment, the secondary power storage component C2 includes a secondary capacitor having a secondary capacitance. The greater the secondary capacitance, the greater the size of the ZVS zone Z defined by the second output power and voltage gain characteristic curve of the secondary bridge circuit 22. The smaller the secondary capacitance, the smaller the size of the ZVS zone Z defined by the second output power and voltage gain characteristic curve of the secondary bridge circuit 22.

In another embodiment shown in FIG. 4C, the bidirectional power converter 1 includes the primary power storage component C1 and the secondary power storage component C2. The primary power storage component C1 is electrically connected between the second end of the primary bridge circuit 21 and the primary power storage element 23 in series, and can store power when charging or discharging the primary bridge circuit 21 and the secondary bridge circuit 22. The secondary power storage component C2 is electrically connected between the first end of the secondary bridge circuit 22 and the secondary coil N2 of the transformer 24 in series, and can store power when charging or discharging the primary bridge circuit 21 and the secondary bridge circuit 22. In this embodiment, the primary power storage component C1 includes the primary capacitor having the primary capacitance. The greater the primary capacitance, the greater the size of the ZVS zone Z defined by the first output power and voltage gain characteristic curve of the primary bridge circuit 21. The smaller the primary capacitance, the smaller the size of the ZVS zone Z defined by the first output power and voltage gain characteristic curve of the primary bridge circuit 21. The secondary power storage component C2 includes the secondary capacitor having the secondary capacitance. The greater the secondary capacitance, the greater the size of the ZVS zone Z defined by the second output power and voltage gain characteristic curve of the secondary bridge circuit 22. The smaller the secondary capacitance, the smaller the size of the ZVS zone Z defined by the second output power and voltage gain characteristic curve of the secondary bridge circuit 22.

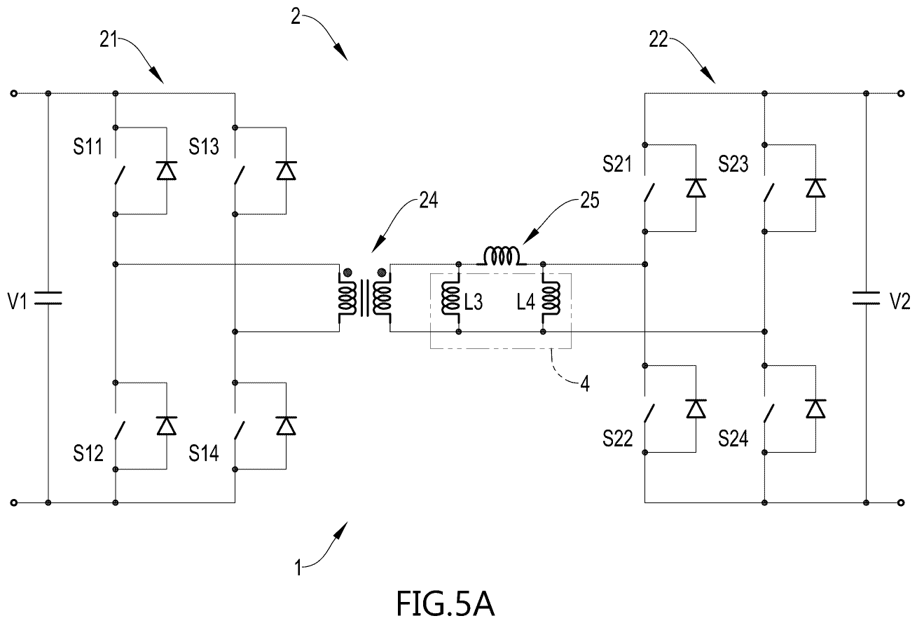

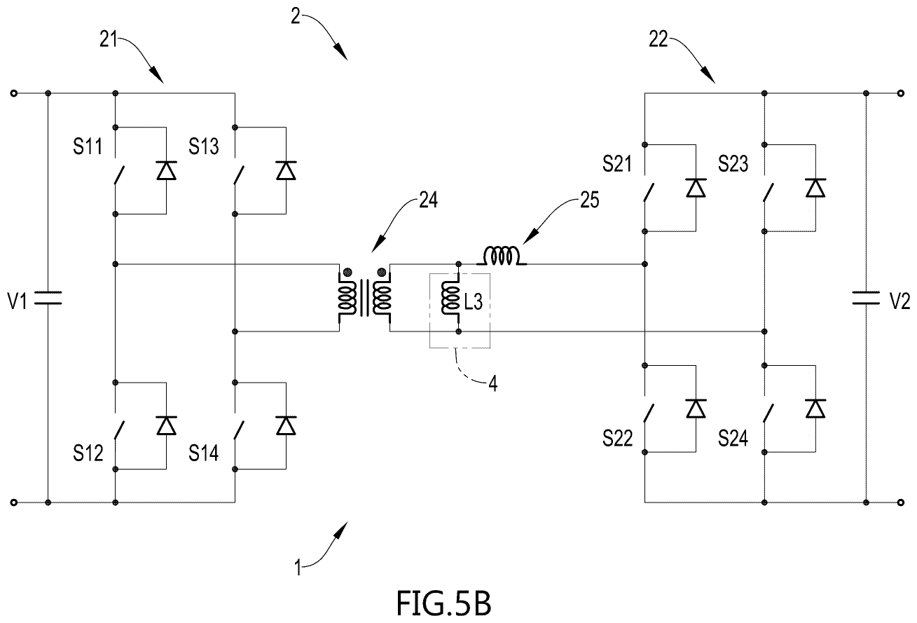

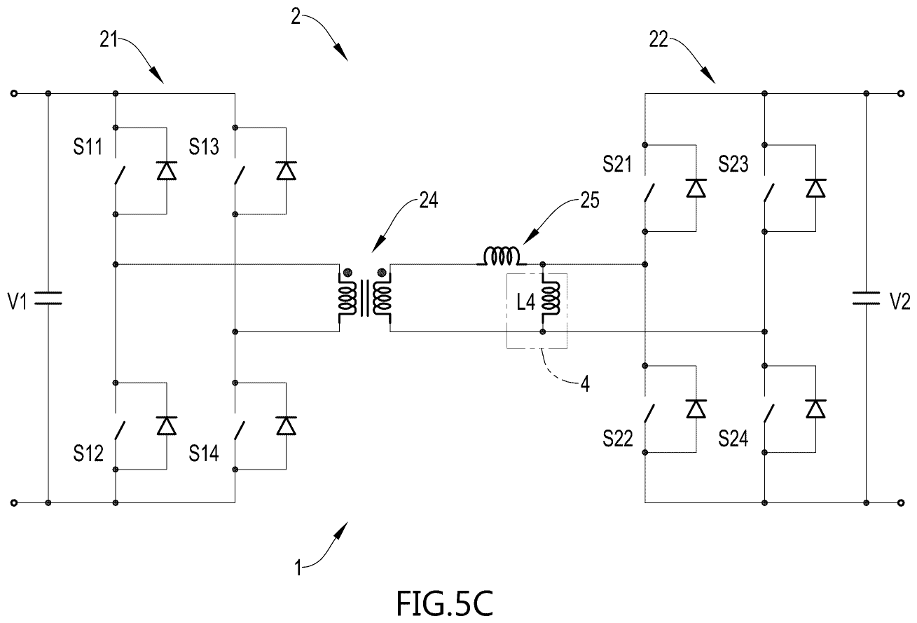

Please refer to FIGS. 5A to 5C, which are schematic diagrams of embodiments of a secondary power storage unit 4 of the bidirectional power converter 1 of the present invention. Differences among the embodiments lie in that the secondary power storage unit 4 and a secondary power storage element 25 are disposed at a secondary side of the transformer 24. Therefore, principles and functions of the secondary power storage unit 4 and the secondary power storage element 25 are similar with those of the embodiments with the primary power storage unit 3. The following descriptions only briefly describe the positions of each component in accordance with the drawings for conciseness.

In embodiments of FIGS. 5A to 5C, the bidirectional power converter 1 includes a DAB converter circuit 2 and the secondary power storage unit 4. The DAB converter circuit 2 includes the primary bridge circuit 21, the secondary bridge circuit 22, the secondary power storage element 25, and the transformer 24. The first end and the second end of the primary bridge circuit 21 are respectively electrically connected to the first signal end V1 and the primary coil N1 of the transformer 24. The second power storage element 25 is electrically connected to the secondary coil N2 of the transformer 24 in series. The first end and the second end of the secondary bridge circuit 22 are respectively electrically connected to the secondary power storage element 25 and the second signal V2. The secondary power storage unit 4 has an impedance and is electrically connected to the secondary coil N2 of the transformer 24 in parallel. The secondary power storage unit 4 stores power when charging or discharging the primary and secondary bridge circuits 21, 22. The primary and secondary bridge circuits 21, 22 are operated in the ZVS zone Z defined by the maximum output power characteristic curve Z₀, the first output power and voltage gain characteristic curve of the primary bridge circuit 21, and the second output power and voltage gain characteristic curve of the secondary bridge circuit 22 to reduce the switching power loss. The first output power and voltage gain characteristic curve of the primary bridge circuit 21 is the curve with the voltage gain m greater than or equal to 1, and the second output power and voltage gain characteristic curve of the secondary bridge circuit 22 is the curve with the voltage gain m smaller than or equal to 1. An amount of power stored in the secondary power storage unit 4 corresponds to a second impedance value of the secondary power storage unit 4, and the second impedance value of the secondary power storage unit 4 corresponds to the size of the ZVS zone.

In FIG. 5A, the secondary power storage unit 4 includes a secondary first inductor L3 disposed between the secondary power storage element 25 and the secondary coil N2 of the transformer 24. The smaller an impedance value of the secondary first inductor L3, the greater the size of the ZVS zone Z defined by the first output power and voltage gain characteristic curve of the primary bridge circuit 21. The greater the impedance value of the secondary first inductor L3, the smaller the size of the ZVS zone Z defined by the first output power and voltage gain characteristic curve of the primary bridge circuit 21.

In FIG. 5B, the secondary power storage unit 4 includes a secondary second inductor L4 disposed between the first end of the secondary bridge circuit 22 and the secondary power storage element 25. The smaller an impedance value of the secondary second inductor L4, the greater the size of the ZVS zone Z defined by the second output power and voltage gain characteristic curve of the secondary bridge circuit 22. The greater the impedance value of the secondary second inductor L4, the smaller the size of the ZVS zone Z defined by the second output power and voltage gain characteristic curve of the secondary bridge circuit 22.

In FIG. 5C, the secondary power storage unit 4 may simultaneously include the secondary first inductor L3 and the secondary second inductor L4. The secondary first inductor L3 is disposed between the secondary power storage element 25 and the secondary coil N2 of the transformer 24, and the secondary second inductor L4 is disposed between the first end of the secondary bridge circuit 22 and the secondary power storage element 25. The smaller the impedance value of the secondary first inductor L3, the greater the size of the ZVS zone Z defined by the first output power and voltage gain characteristic curve of the primary bridge circuit 21. The greater the impedance value of the secondary first inductor L3, the smaller the size of the ZVS zone Z defined by the first output power and voltage gain characteristic curve of the primary bridge circuit 21. Further, the smaller the impedance value of the secondary second inductor L4, the greater the size of the ZVS zone Z defined by the second output power and voltage gain characteristic curve of the secondary bridge circuit 22. The greater the impedance value of the secondary second inductor L4, the smaller the size of the ZVS zone Z defined by the second output power and voltage gain characteristic curve of the secondary bridge circuit 22.

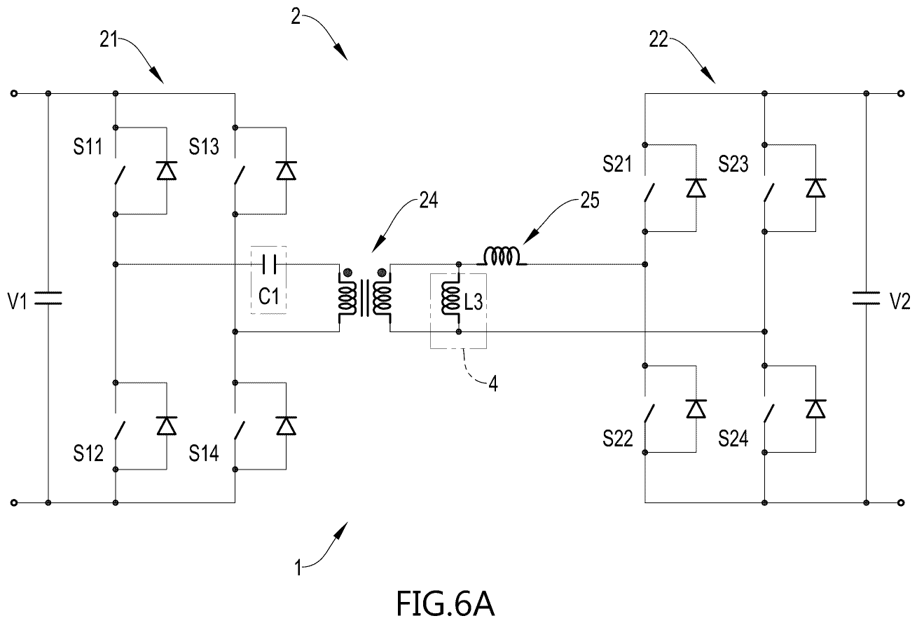

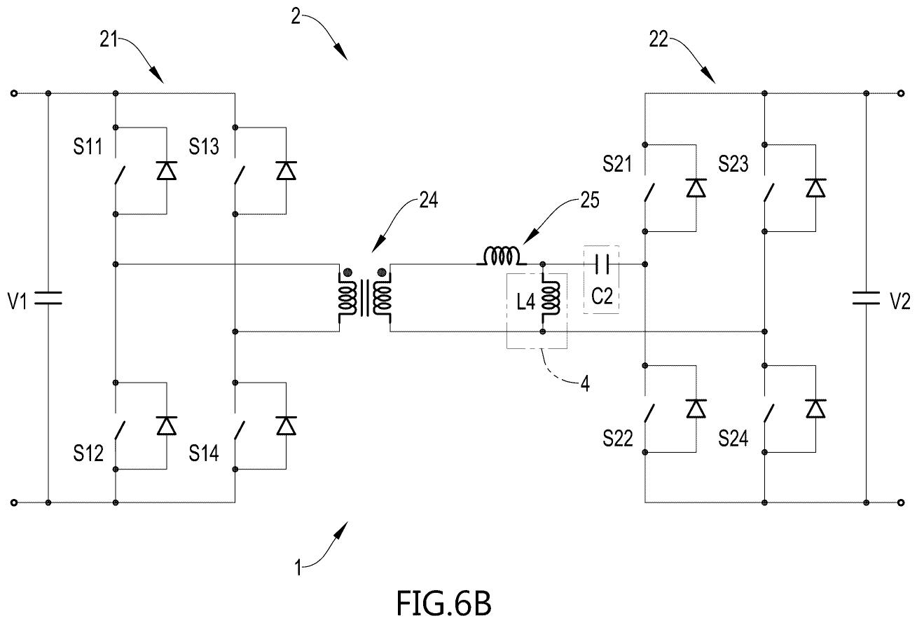

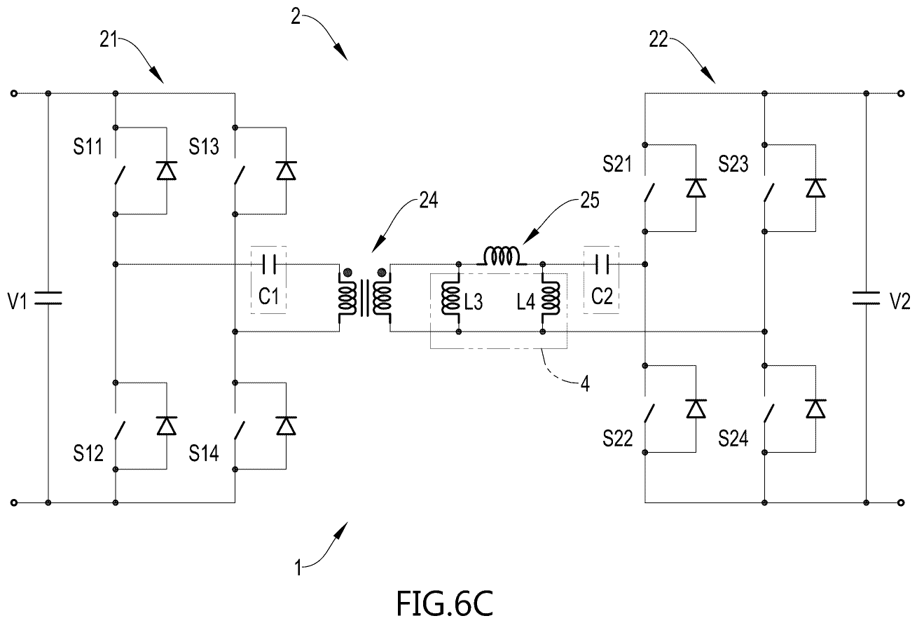

Please refer to FIGS. 6A to 6C, which are schematic diagrams of embodiments of the secondary power storage component C2. In embodiments of FIGS. 6A to 6C, similar with the embodiments of FIGS. 4A to 4C, a primary side of the transformer 24 can include the primary power storage component C1, the secondary side of the transformer 24 can include the secondary power storage component C2, or the transformer 24 can both include the primary power storage component C1 at the primary side and the secondary power storage component C2 at the secondary side.

In FIG. 6A, the primary power storage component C1 is electrically connected between the second end of the primary bridge circuit 21 and the primary coil N1 of the transformer 24 in series, and the primary power storage component C1 can store power when charging or discharging the primary and secondary bridge circuits 21, 22. The primary power storage component C1 includes a primary capacitor having the primary capacitance. The greater the primary capacitance, the greater the size of the ZVS zone Z defined by the first output power and voltage gain characteristic curve of the primary bridge circuit 21. The smaller the primary capacitance, the smaller the size of the ZVS zone Z defined by the first output power and voltage gain characteristic curve of the primary bridge circuit 21.

In FIG. 6B, the secondary power storage component C2 is electrically connected between the first end of the secondary bridge circuit 22 and the secondary power storage element 25 in series, and the secondary power storage component C2 can store power when charging or discharging the primary and secondary bridge circuits 21, 22. The secondary power storage component C2 includes the secondary capacitor having the secondary capacitance. The greater the secondary capacitance, the greater the size of the ZVS zone Z defined by the second output power and voltage gain characteristic curve of the secondary bridge circuit 22. The smaller the secondary capacitance, the smaller the size of the ZVS zone Z defined by the second output power and voltage gain characteristic curve of the secondary bridge circuit 22.

In FIG. 6C, the primary power storage component C1 is electrically connected between the second end of the primary bridge circuit 21 and the primary coil N1 of the transform 24 in series, and the primary power storage component C1 can store power when charging or discharging the primary and secondary bridge circuits 21, 22. The primary power storage component C1 includes the primary capacitor having the primary capacitance. The greater the primary capacitance, the greater the size of the ZVS zone Z defined by the first output power and voltage gain characteristic curve of the primary bridge circuit 21. The smaller the primary capacitance, the smaller the size of the ZVS zone Z defined by the first output power and voltage gain characteristic curve of the primary bridge circuit 21. The secondary power storage component C2 is electrically connected between the first end of the secondary bridge circuit 22 and the secondary power storage element 25 in series, and the secondary power storage component C2 can store power when charging or discharging the primary bridge circuit 21 and the secondary bridge circuit 22. The secondary power storage component C2 includes the secondary capacitor having the secondary capacitance. The greater the secondary capacitance, the greater the size of the ZVS zone Z defined by the second output power and voltage gain characteristic curve of the secondary bridge circuit 22. The smaller the secondary capacitance, the smaller the size of the ZVS zone Z defined by the second output power and voltage gain characteristic curve of the secondary bridge circuit 22.

The size of the ZVS zone Z defined by the maximum output power characteristic curve Z₀, the first output power and voltage gain characteristic curve of the primary bridge circuit 21, the second output power and voltage gain characteristic curve of the secondary bridge circuit 22 in the charging mode and the discharging mode of the primary bridge circuit 21, the secondary bridge circuit 22, the primary power storage unit 3, and the secondary power storage unit 4 are calculated by the normalization algorithm. Further, the first impedance value of the primary power storage unit 3 and the second impedance value of the secondary power storage unit 4 are both calculated by the normalization algorithm. During calculating by the normalization algorithm, error factors must be considered, including component error factors of the primary bridge circuit 21, the secondary bridge circuit 22, the primary power storage unit 3, the secondary power storage unit 4, the primary power storage element 23, the secondary power storage element 25, and the transformer 24. Moreover, safety factors also need to be considered to avoid the bidirectional power converter 1 operating out of the ZVS zone Z in the charging mode and the discharging mode.

To illustrate an operation process of the bidirectional power converter 1 in the present invention with actual data, the following data is provided for FIG. 1A. However, it should be noted that the following data are merely exemplary and by no means limiting.

With reference to FIG. 1A, when the bidirectional power converter 1 is operated in the charging mode, the power flows from the first signal end V1 to the second signal end V2. A first voltage value of the first signal end V1 is between 365 Volts and 415 Volts. A second voltage value of the second signal end V2 is between 25 Volts and 50.4 Volts. A value of a charging current of the second signal end V2 is 21 Amperes. When the second signal end V2 is charged to a maximum voltage, the charging current of the second signal end V2 is decreased, and the minimum of the charging current is 5 Amperes. When the bidirectional power converter 1 is operated in the discharging mode, the power flows from the second signal end V2 to the first signal end V1. The first voltage value of the first signal end V1 is between 365 Volts and 415 Volts. The second voltage value of the second signal end V2 is between 25 Volts and 50.4 Volts. A value of a discharging current of the second signal end V2 is 15 Amperes.

For designing circuit parameters of the bidirectional power converter 1, it is necessary to consider whether the ZVS boundary power and switching current are sufficient to discharge a switching output capacitor. Therefore, to simplify calculations, the following content does not calculate whether the switching current is sufficient to discharge the switching output capacitor but assumes that a direction of the switching current is correct to achieve the effect of the ZVS.

Firstly, variables are defined as follows. A minimum charging input voltage V1_{ch_min}=365. A maximum charging input voltage V1_{ch_max}=415. A charging current I2_{ch_typ}=21. A minimum charging current at a max output voltage I2_{ch_min}=5. A minimum discharging output voltage V1_{disch_min}=365. A maximum discharging output voltage V1_{disch_max}=385. A discharging current I2_{disch}=15. A minimum voltage of the second signal end V2 V2ₘᵢₙ=25. A maximum voltage of the second signal end V2 V2ₘₐₓ=50.4. A base frequency is selected, and a switching frequency is set constant. Namely, a normalized operation frequency fₙ=1, and F_{B}=F_{sw}=80 KHZ. The base inductor value L_{B}=2πLₛ, and the base impedance value Z_{B}=ω_{B}L_{B}=2πF_{sw}Lₛ. The base inductor value and the base impedance value are independent with an input voltage.

Since a maximum output power of the bidirectional power converter 1 is affected by the transformer turns ratio N_{xfmr} and the inductor Lₛ, the transformer turns ratio N_{xfmr} and the inductor Lₛ are selected to ensure that the bidirectional power converter 1 can stably output power under any operating conditions. The following explains the operations of the bidirectional power converter 1 in the charging mode and the discharging mode.

In the charging mode, the first signal end V1 is leading, and the second signal end V2 is lagging. Therefore, in the following process of the normalization algorithm, a voltage of the first signal end V1 is the base voltage V_{B}, and V_{B}=V1_{ch}. Since the base voltage V_{B} is the voltage of the first signal end V1, the base voltage V_{B} changes according to the voltage of the first signal end V1.

Namely, the voltage gain

$$m = \frac{{N}_{xfmr} {V}_{2}}{{V 1}_{c h}} ;$$

$${I}_{B} = \frac{V {1}_{c h}}{{Z}_{B}} ;$$

$${P}_{B} = \frac{V {1}_{ch}^{2}}{{Z}_{B}} ;$$

A maximum charging load of the bidirectional power converter 1 is p_{ch_max}(m, j_{ch})=m·j_{ch}. The j_{ch} is a normalized charging current. The normalized charging current needs to satisfy the following relations for ensuring stable output under any operation conditions.

$${P}_{ch \_ max} ( m , {j}_{c h} ) \leq {P}_{max} ( π , m ) ;$$

$${j}_{c h} \leq \frac{1}{4} π ;$$

The above relations can be multiplied by a charging safety factor to avoid engineering errors. In this embodiment of the present invention, the selected charging safety factor is 80%, adjustable according to actual situations.

$${j}_{c h} \leq \frac{1}{4} π \times 80 \% ;$$

$$\frac{\frac{{I}_{ch}}{{N}_{xfmr}}}{\frac{V {1}_{c h}}{{Z}_{B}}} \leq \frac{1}{4} π \times 80 \% ;$$

$$\frac{{Z}_{B}}{{N}_{xfmr}} \leq \frac{1}{4} π \times 80 \% \times \frac{{V 1}_{c h}}{{I}_{c h}} ;$$

A minimum of V1_{ch} is V1_{ch_min}.

$$\frac{{Z}_{B}}{{N}_{xfmr}} \leq 10.921 ;$$

In the discharging mode, the second signal end V2 is leading, and the first signal end V1 is lagging. The discharging current of the second signal end V2 is 15 Amperes, and a load curve would not change with the output.

In the following process of the normalization algorithm, a voltage of the second signal end V2 is the base voltage V_{B}, and V_{B}=V2. Since the base voltage V_{B} is the voltage of the second signal end V2, the base voltage V_{B} changes according to the voltage of the second signal end V1.

$$m = \frac{V {1}_{disch}}{V 2} ;$$

$${T}_{B} = \frac{V 2}{{Z}_{B}} ;$$

$${P}_{B} = \frac{V {2}^{2}}{{Z}_{B}} ;$$

A discharging load of the bidirectional power converter 1 is p_{disch}(j_{disch})=j_{disch}. j_{disch} is the normalized discharging current, and the normalized discharging current needs to satisfy the following relations to ensure stable output under any operating conditions.

$${p}_{disch} ( {j}_{disch} ) \leq {P}_{max} ( π , m ) ;$$

$${j}_{disch} \leq \frac{1}{4} π m ;$$

The above relations can be multiplied by a discharging safety factor to avoid engineering errors. In this embodiment of the present invention, the selected discharging safety factor is 80%, adjustable according to actual situations.

$${j}_{disch} \leq \frac{1}{4} π m \times 80 \% ;$$

$$\frac{\frac{{J}_{disch}}{{N}_{xfmr}}}{\frac{{N}_{xfmr} {V}^{2}}{{Z}_{B}}} \leq \frac{1}{4} π \times \frac{V {1}_{disch}}{{N}_{xfmr} {V}^{2}} \times 80 \% ;$$

$$\frac{{Z}_{B}}{{N}_{xfmr}} \leq \frac{1}{4} π \times 80 \% \times \frac{V {1}_{disch}}{{I}_{disch}} ;$$

A minimum of V1_{disch} IS V1_{disch_min}.

$$\frac{{Z}_{B}}{{N}_{xfmr}} \leq 15.289 ;$$

Since

$$\frac{{Z}_{B}}{{N}_{xfmr}}$$

needs to satisfy the conditions of the charging mode and the discharging mode,

$$\frac{{Z}_{B}}{{N}_{xfmr}} \leq 10.9 \; 21 , and {N}_{xfmr} = ceil ( \frac{V {1}_{ch \_ min}}{V {2}_{max}} ) = 8.$$

Therefore, Z_{B}≤87.366⇒Ls≤173.810 (μH), and Ls=175 (μH). Further, since the relations are adjusted according to the safety factor, a value slightly larger than the limit value is acceptable. When N_{xfmr} and Ls are determined, the primary first and second inductors L1, L2 can be calculated.

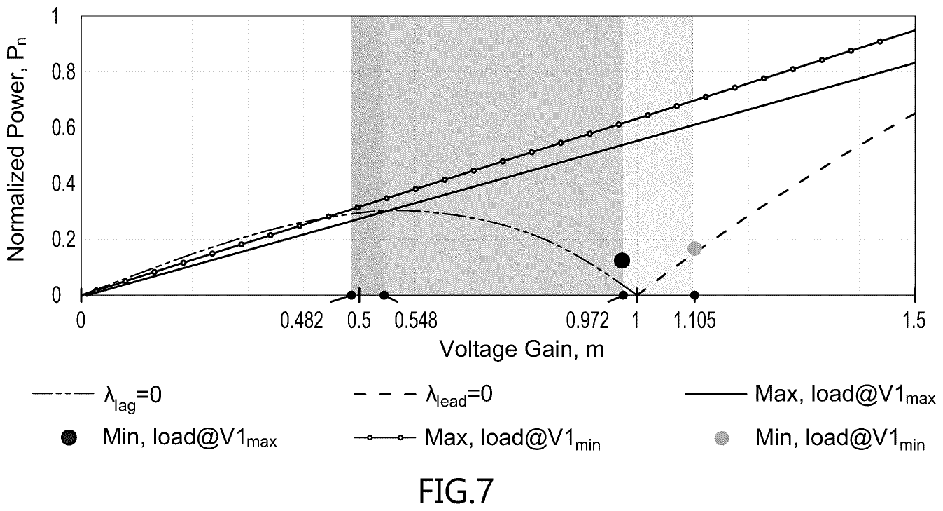

Please refer to FIG. 7, which is a schematic boundary power and load distribution diagram of a ZVS range of an original normalized charging mode. In the charging mode, an operation gain range of V1_{ch_max} is between 0.482 and 0.972. A curve of “Max, load@V1ₘₐₓ” is a normalized output load curve corresponding to V1_{ch_max}. A dot point in the curve of “Max, load@V1ₘₐₓ” a minimum normalized output load at a maximum output voltage. An operation gain range of V1_{ch_min} is between 0.548 and 1.105. A curve of “Max, load@V1ₘᵢₙ” is a normalized output load curve corresponding to V1_{ch_min}. A dot point in the curve of “Max, load@V1ₘᵢₙ” is a minimum normalized output load at a minimum output voltage.

Two problems and their improvement method can be determined from FIG. 7. A first problem is that when the bidirectional power converter 1 is operated at V1_{ch_max} and a minimum output voltage, such as a point of a minimum voltage gain, the output power is smaller than the boundary power of the ZVS, and real physical quantities are as follows:

$$output power : {P}_{{min \_ V 1}_{ch \_ max}} = V {2}_{min} \times I {2}_{ch \_ typ} = 525 W ;$$

$$boundary power of ZVS : {p}_{lag \_ zvs} ( π , \frac{{N}_{p}}{{N}_{s}} \times \frac{V {2}_{min}}{V {1}_{ch \_ max}} , 0 ) \times {P}_{{B \_ V 1}_{ch \_ max}} = 568.954 W ;$$

$${P}_{{B \_ V 1}_{ch \_ max}} = \frac{V {1}_{ch \_ max}^{2}}{2 π \times {F}_{s w} \times {L}_{s}} ;$$

λ_{lag_ch} is adjusted to let p_{lag_zvs} be 80% of the output power for ensuring that there are sufficient allowable error ranges of the boundary power of the ZVS and an actual output power. Namely, the 80% is a safety factor, adjustable according to an actual application.

$${p}_{lag \_ zvs} ( π , \frac{{N}_{p}}{{N}_{s}} \times \frac{V {2}_{min}}{V {1}_{ch \_ max}} , {λ}_{lag \_ ch} ) = 80 \% \times {V 2}_{min} \times \frac{I {2}_{ch \_ typ}}{{P}_{{B \_ V 1}_{ch \_ max}}} ;$$

$${λ}_{lag \_ ch} = \frac{{L}_{s}}{L {2}_{c h}} = 0 \text{.366} ;$$

$$L {2}_{c h} = 478.3 \; 96 ( μH ) ;$$

A second problem is that when the bidirectional power converter 1 is operated at V1_{ch_min} and a maximum output voltage, such as a point of a maximum voltage gain, the output power is very close to the boundary power of the ZVS, and real physical quantities are as follows:

$$output power : {P}_{{min \_ V 1}_{ch \_ min}} = {V 2}_{max} \times I {2}_{ch \_ min} = 50.4 \times 5 = 252 W ;$$

$$boundary power of ZVS : {p}_{lead \_ zvs} ( π , \frac{{N}_{p}}{{N}_{s}} \times \frac{V {2}_{max}}{V {1}_{ch \_ min}} , 0 ) \times {P}_{{B \_ V 1}_{ch \_ min}} = 237.188 W ;$$

$${P}_{{B \_ V 1}_{ch \_ min}} = \frac{V {1}_{ch \_ min}^{2}}{2 π \times {F}_{s w} \times {L}_{s}} ;$$

Similarly, λ_{lead}_ch is adjusted to let p_{lead_zvs} be 50% of the output power, and this 50% is a safety factor, adjustable according to an actual application.

$${p}_{lead \_ zvs} ( π , \frac{{N}_{p}}{{N}_{s}} \times \frac{V {o}_{max}}{V {1}_{min}} , {λ}_{lead \_ ch} ) = 50 \% \times V {2}_{max} \times \frac{I {2}_{ch \_ min}}{{P}_{{B \_ V 1}_{ch \_ min}}} ;$$

$${λ}_{lead \_ ch} = \frac{{L}_{s}}{L {1}_{c h}} = 0 \text{.050} ;$$

$$L {1}_{c h} = 3.4 \; 75 ( mH ) ;$$

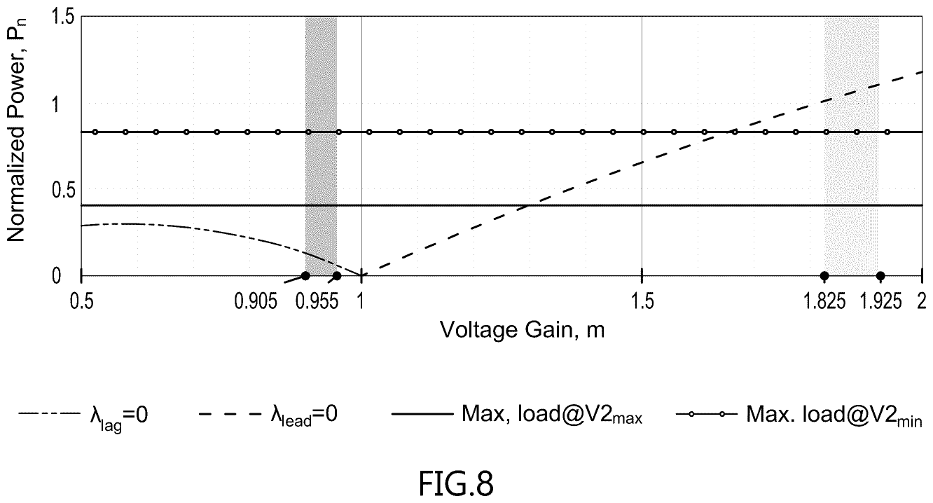

Please refer to FIG. 8, which is a schematic boundary power and load distribution diagram of a ZVS range of an original normalized discharging mode. In the discharging mode, an operation gain range of V2ₘₐₓ is between 0.905 and 0.955. A curve of “Max, load@V2ₘₐₓ” is a normalized output load curve corresponding to V2ₘₐₓ. An operation gain range of V2ₘᵢₙ is between 1.825 and 1.925. A curve of “Max, load@V2ₘᵢₙ” is a normalized output load curve corresponding to V2ₘᵢₙ. In FIG. 8, when the bidirectional power converter 1 is operated at V2ₘᵢₙ, all ranges cannot reach ZVS, that is, the bidirectional power converter 1 cannot perform the ZVS. Therefore, λ_{lead}_disch is adjusted to let p_{lead_zvs} be 80% of the output power, and this 80% is a safety factor, adjustable according to an actual application.

$${P}_{lead \_ zvs} ( π , \frac{{V 1}_{disch \_ max}}{\frac{{N}_{p}}{{N}_{s}} \times V {2}_{min}} , {λ}_{lead \_ disch} ) = 80 \% \times V {2}_{min} \times \frac{{I}_{disch}}{{P}_{B \_ V {2}_{min}}} ;$$

$${P}_{{B \_ V 2}_{min}} = \frac{V {2}_{min}^{2}}{2 π \times {F}_{s w} \times {L}_{s}} ;$$

$${λ}_{lead \_ disch} = \frac{{L}_{s}}{L {2}_{disch}} = 0 \text{.445} ;$$

$$L {2}_{disch} = 393.0 \; 75 ( μH ) ;$$

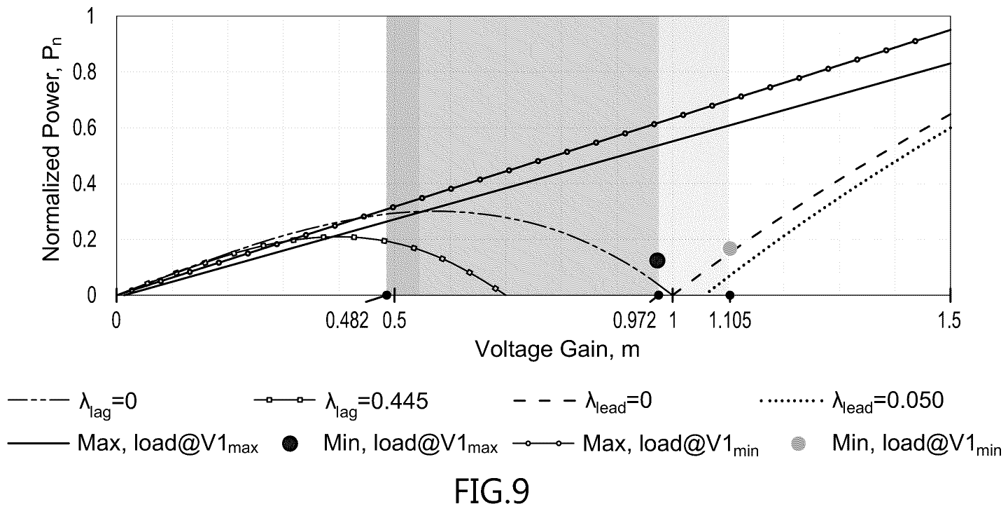

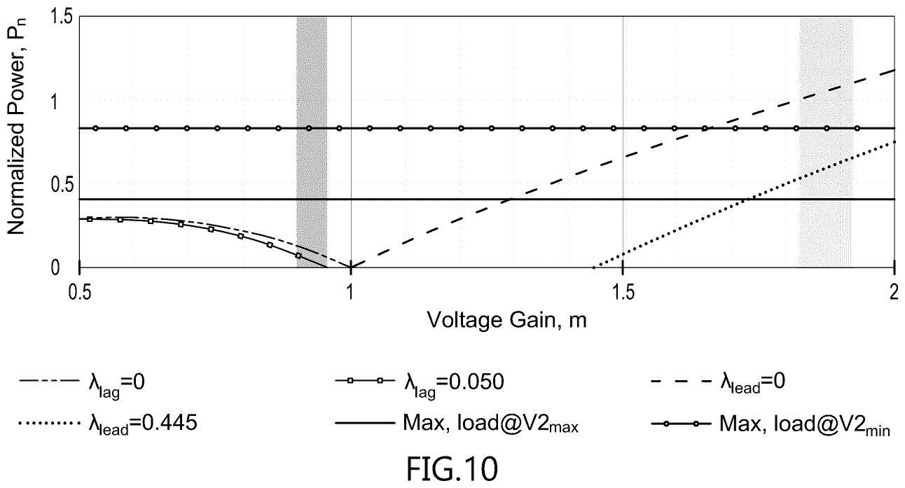

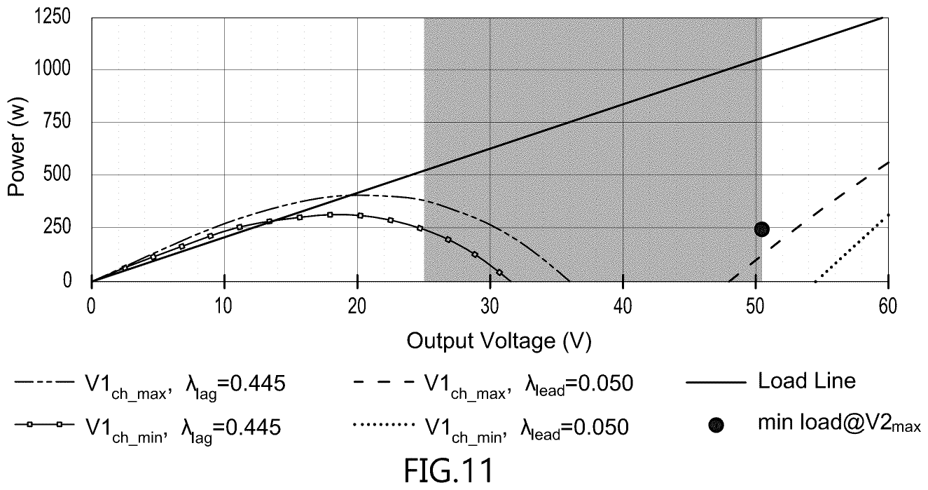

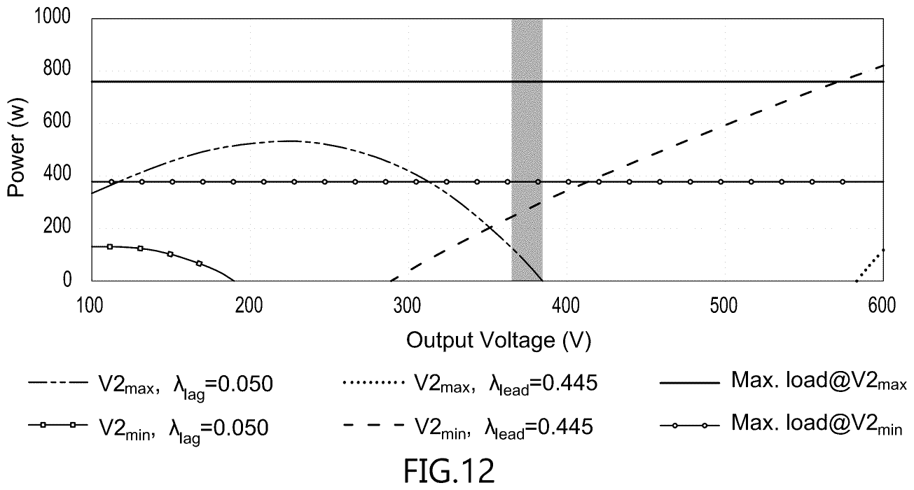

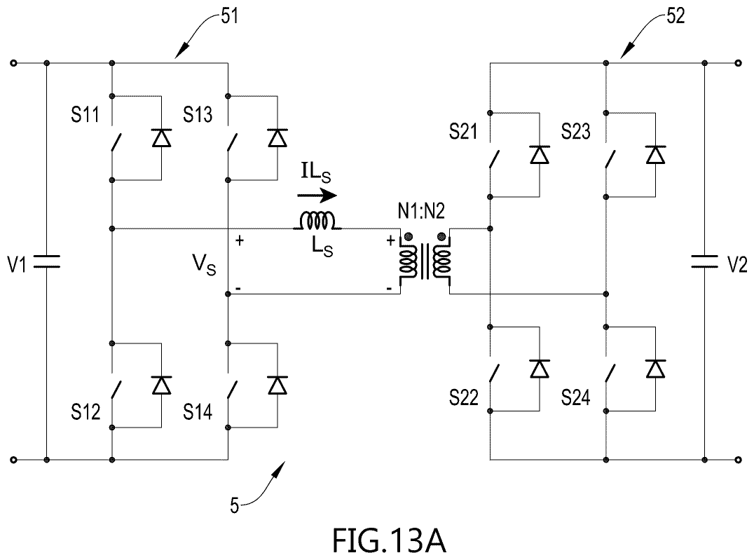

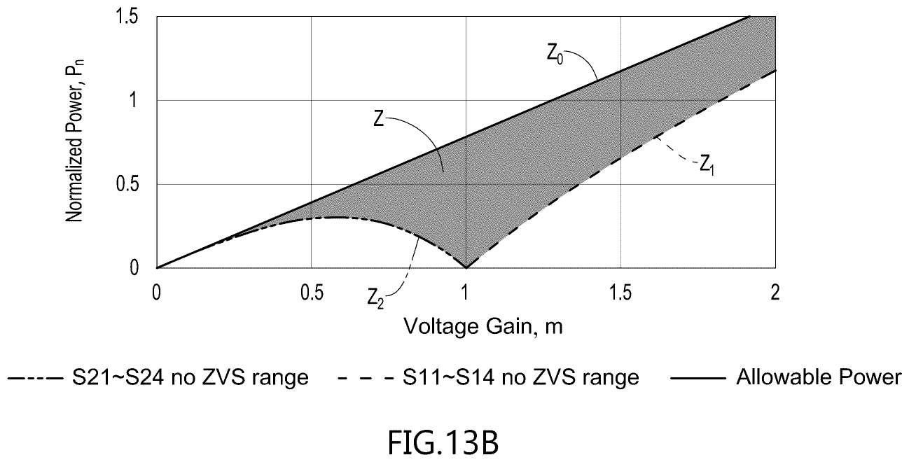

Please refer to FIGS. 9 and 10, which are schematic ZVS diagrams of the primary first inductor L1 and the primary second inductor L2. Minimum inductances of the primary first and second inductors L1, L2 in any conditions are selected, such as L1=3.475 (mH) and L2=min(L2_{ch}, L2_{disch})=393.075 (μH). FIGS. 11 and 12 are schematic diagrams of actual ZVS boundary power change and load curves after restoring a normalization, that is, powers and output voltage shown in FIGS. 11 and 12 are actual measured physical quantities. Namely, a charging power and output voltage characteristic curve in the charging mode and a discharging power and output voltage characteristic curve in the discharging mode of the primary bridge circuit, the secondary bridge circuit, the primary power storage unit, and the secondary power storage unit are generated by restoring a normalized power and a normalized voltage gain with the normalization algorithm, and a size of a restored ZVS zone is defined by the charging power and output voltage characteristic curve in the charging mode and the discharging power and output voltage characteristic curve in the discharging mode of the primary bridge circuit, the secondary bridge circuit, the primary power storage unit, and the secondary power storage unit.

Even though numerous characteristics and advantages of the present invention have been set forth in the foregoing description, together with details of the structure and function of the invention, the disclosure is illustrative only. Changes may be made in detail, especially in matters of shape, size, and arrangement of parts within the principles of the invention to the full extent indicated by the broad general meaning of the terms in which the appended claims are expressed.

What is claimed is:

1. A bidirectional power converter, comprising:
a dual active bridge (DAB) converter circuit, comprising a primary bridge circuit, a secondary bridge circuit, a primary power storage element, and a transformer; wherein a first end and a second end of the primary bridge circuit are respectively electrically connected to a first signal end and the primary power storage element, the primary power storage element is electrically connected to a primary coil of the transformer in series, and a first end and a second end of the secondary bridge circuit are respectively electrically connected to a secondary coil of the transformer and a second signal end; and
a primary power storage unit, having a first impedance value and electrically connected to the primary coil of the transformer in parallel; wherein the primary power storage unit stores power when charging or discharging the primary bridge circuit and the secondary bridge circuit;
wherein the primary bridge circuit and the secondary bridge circuit are operated in a zero-voltage-switching (ZVS) zone defined by a maximum output power characteristic curve, a first output power and voltage gain characteristic curve of the primary bridge circuit, and a second output power and voltage gain characteristic curve of the secondary bridge circuit;
wherein the first output power and voltage gain characteristic curve of the primary bridge circuit is a curve with a voltage gain greater than or equal to 1, and the second output power and voltage gain characteristic curve of the secondary bridge circuit is a curve with a voltage gain smaller than or equal to 1; and
wherein an amount of power stored in the primary power storage unit corresponds to the first impedance value of the primary power storage unit, and the first impedance value of the primary power storage unit corresponds to a size of the ZVS zone.

2. The bidirectional power converter as claimed in claim 1, wherein the primary power storage unit comprises a primary first inductor disposed between the second end of the primary bridge circuit and the primary power storage element;
wherein the smaller an impedance value of the primary first inductor, the greater a size of the ZVS zone defined by the first output power and voltage gain characteristic curve of the primary bridge circuit; and
wherein the greater the impedance value of the primary first inductor, the smaller the size of the ZVS zone defined by the first output power and voltage gain characteristic curve of the primary bridge circuit.

3. The bidirectional power converter as claimed in claim 1, wherein the primary power storage unit comprises a primary second inductor disposed between the primary power storage element and the primary coil of the transformer; and
wherein the smaller an impedance value of the primary second inductor, the greater a size of the ZVS zone defined by the second output power and voltage gain characteristic curve of the secondary bridge circuit; and
wherein the greater the impedance value of the primary second inductor, the smaller the size of the ZVS zone defined by the second output power and voltage gain characteristic curve of the secondary bridge circuit.

4. The bidirectional power converter as claimed in claim 1, wherein the primary power storage unit comprises a primary first inductor and a primary second inductor; the primary first inductor is disposed between the second end of the primary bridge circuit and the primary power storage element, and the primary second inductor is disposed between the primary power storage element and the primary coil of the transformer;
wherein the smaller the impedance value of the primary first inductor, the greater the size of the ZVS zone defined by the first output power and voltage gain characteristic curve of the primary bridge circuit; the greater the impedance value of the primary first inductor, the smaller the size of the ZVS zone defined by the first output power and voltage gain characteristic curve of the primary bridge circuit; and
wherein the smaller the impedance value of the primary second inductor, the greater the size of the ZVS zone defined by the second output power and voltage gain characteristic curve of the secondary bridge circuit; the greater the impedance value of the primary second inductor, the smaller the size of the ZVS zone defined by the second output power and voltage gain characteristic curve of the secondary bridge circuit.

5. The bidirectional power converter as claimed in claim 1, further comprising:
a primary power storage component, electrically connected between the second end of the primary bridge circuit and the primary power storage element in series; wherein the primary power storage component stores power when charging or discharging the primary bridge circuit and the secondary bridge circuit;
a secondary power storage component, electrically connected between the first end of the secondary bridge circuit and the secondary coil of the transformer in series; wherein the secondary power storage component stores power when charging or discharging the primary bridge circuit and the secondary bridge circuit;
wherein the primary power storage component comprises a primary capacitor having a primary capacitance;
wherein the greater the primary capacitance, the greater the size of the ZVS zone defined by the first output power and voltage gain characteristic curve of the primary bridge circuit;
wherein the smaller the primary capacitance, the smaller the size of the ZVS zone defined by the first output power and voltage gain characteristic curve of the primary bridge circuit;
wherein the secondary power storage component comprises a secondary capacitor having a secondary capacitance; and
wherein the greater the secondary capacitance, the greater the size of the ZVS zone defined by the second output power and voltage gain characteristic curve of the secondary bridge circuit; the smaller the secondary capacitance, the smaller the size of the ZVS zone defined by the second output power and voltage gain characteristic curve of the secondary bridge circuit.

6. The bidirectional power converter as claimed in claim 1, further comprising:
a secondary power storage component, electrically connected between the first end of the secondary bridge circuit and the secondary coil of the transformer in series; wherein the secondary power storage component stores power when charging or discharging the primary bridge circuit and the secondary bridge circuit;
wherein the secondary power storage component comprises a secondary capacitor having a secondary capacitance;
wherein the greater the secondary capacitance, the greater the size of the ZVS zone defined by the second output power and voltage gain characteristic curve of the secondary bridge circuit; and
wherein the smaller the secondary capacitance, the smaller the size of the ZVS zone defined by the second output power and voltage gain characteristic curve of the secondary bridge circuit.

7. The bidirectional power converter as claimed in claim 1, wherein the size of the ZVS zone and the first impedance value of the primary power storage unit are generated by a normalization algorithm; and
wherein the size of the ZVS zone is defined by the maximum output power characteristic curve, the first output power and voltage gain characteristic curve of the primary bridge circuit, and the second output power and voltage gain characteristic curve of the secondary bridge circuit in a charging mode and a discharging mode of the primary bridge circuit, the secondary bridge circuit, and the primary power storage unit.

8. The bidirectional power converter as claimed in claim 7, wherein a size of a restored ZVS zone is generated by restoring the maximum output power characteristic curve, the first output power and voltage gain characteristic curve of the primary bridge circuit, the second output power and voltage gain characteristic curve of the secondary bridge circuit, and the first impedance value of the primary power storage unit with the normalization algorithm; and
wherein the size of the restored ZVS zone is defined by a charging power and output voltage characteristic curve in the charging mode and a discharging power and output voltage characteristic curve in the discharging mode of the primary bridge circuit, the secondary bridge circuit, and the primary power storage unit.

9. The bidirectional power converter as claimed in claim 7, wherein the size of the ZVS zone and the first impedance value of the primary power storage unit are generated by the normalization algorithm according to a component error factor of at least one of the primary bridge circuit, the secondary bridge circuit, the primary power storage unit, the primary power storage element, and the transformer; and
wherein the size of the ZVS zone is defined by the maximum output power characteristic curve, the first output power and voltage gain characteristic curve of the primary bridge circuit, and the second output power and voltage gain characteristic curve of the secondary bridge circuit in the charging mode and the discharging mode of the primary bridge circuit, the secondary bridge circuit, and the primary power storage unit.

10. The bidirectional power converter as claimed in claim 9, wherein the size of the ZVS zone and the first impedance value of the primary power storage unit are generated by the normalization algorithm according to a safety factor; and
wherein the size of the ZVS zone is defined by the maximum output power characteristic curve, the first output power and voltage gain characteristic curve of the primary bridge circuit, and the second output power and voltage gain characteristic curve of the secondary bridge circuit in the charging mode and the discharging mode of the primary bridge circuit, the secondary bridge circuit, and the primary power storage unit.

11. A bidirectional power converter, comprising:
a DAB converter circuit, comprising a primary bridge circuit, a secondary bridge circuit, a secondary power storage element, and a transformer; wherein a first end and a second end of the primary bridge circuit are respectively electrically connected to a first signal end and a primary coil of the transformer, the second power storage element is electrically connected to a secondary coil of the transformer in series, and a first end and a second end of the secondary bridge circuit are respectively electrically connected to the secondary power storage element and a second signal;
a secondary power storage unit, having an impedance and electrically connected to the secondary coil of the transformer in parallel; wherein the secondary power storage unit stores power when charging or discharging the primary bridge circuit and the secondary bridge circuit;
wherein the primary bridge circuit and the secondary bridge circuit are operated in a ZVS zone defined by a maximum output power characteristic curve, a first output power and voltage gain characteristic curve of the primary bridge circuit, and a second output power and voltage gain characteristic curve of the secondary bridge circuit;
wherein the first output power and voltage gain characteristic curve of the primary bridge circuit is the curve with the voltage gain greater than or equal to 1, and the second output power and voltage gain characteristic curve of the secondary bridge circuit is the curve with the voltage gain smaller than or equal to 1; and
wherein an amount of power stored in the secondary power storage unit corresponds to a second impedance value of the secondary power storage unit, and the second impedance value of the secondary power storage unit corresponds to a size of the ZVS zone.

12. The bidirectional power converter as claimed in claim 11, wherein the secondary power storage unit comprises a secondary first inductor disposed between the secondary power storage element and the secondary coil of the transformer;
wherein the smaller an impedance value of the secondary first inductor, the greater the size of the ZVS zone defined by the first output power and voltage gain characteristic curve of the primary bridge circuit; and
wherein the greater the impedance value of the secondary first inductor, the smaller the size of the ZVS zone defined by the first output power and voltage gain characteristic curve of the primary bridge circuit.

13. The bidirectional power converter as claimed in claim 11, wherein the secondary power storage unit comprises a secondary second inductor disposed between the first end of the secondary bridge circuit and the secondary power storage element;
wherein the smaller an impedance value of the secondary second inductor, the greater the size of the ZVS zone defined by the second output power and voltage gain characteristic curve of the secondary bridge circuit; and
wherein the greater the impedance value of the secondary second inductor, the smaller the size of the ZVS zone defined by the second output power and voltage gain characteristic curve of the secondary bridge circuit.

14. The bidirectional power converter as claimed in claim 11, wherein the secondary power storage unit comprises a secondary first inductor and a secondary second inductor;
wherein the secondary first inductor is disposed between the secondary power storage element and the secondary coil of the transformer; the secondary second inductor is disposed between the first end of the secondary bridge circuit and the secondary power storage element;
wherein the smaller an impedance value of the secondary first inductor, the greater the size of the ZVS zone defined by the first output power and voltage gain characteristic curve of the primary bridge circuit; the greater the impedance value of the secondary first inductor, the smaller the size of the ZVS zone defined by the first output power and voltage gain characteristic curve of the primary bridge circuit;
wherein the smaller an impedance value of the secondary second inductor, the greater the size of the ZVS zone defined by the second output power and voltage gain characteristic curve of the secondary bridge circuit; and
wherein the greater the impedance value of the secondary second inductor, the smaller the size of the ZVS zone defined by the second output power and voltage gain characteristic curve of the secondary bridge circuit.

15. The bidirectional power converter as claimed in claim 11, further comprising:
a primary power storage component, electrically connected between the second end of the primary bridge circuit and the primary coil of the transformer in series; wherein the primary power storage component stores power when charging or discharging the primary bridge circuit and the secondary bridge circuit;
a secondary power storage component, electrically connected between the first end of the secondary bridge circuit and the secondary power storage element in series; wherein the secondary power storage component stores power when charging or discharging the primary bridge circuit and the secondary bridge circuit;
wherein the primary power storage component comprises a primary capacitor having a primary capacitance;
wherein the greater the primary capacitance, the greater the size of the ZVS zone defined by the first output power and voltage gain characteristic curve of the primary bridge circuit;
wherein the smaller the primary capacitance, the smaller the size of the ZVS zone defined by the first output power and voltage gain characteristic curve of the primary bridge circuit;
wherein the secondary power storage component comprises a secondary capacitor having a secondary capacitance;
wherein the greater the secondary capacitance, the greater the size of the ZVS zone defined by the second output power and voltage gain characteristic curve of the secondary bridge circuit; and
wherein the smaller the secondary capacitance, the smaller the size of the ZVS zone defined by the second output power and voltage gain characteristic curve of the secondary bridge circuit.

16. The bidirectional power converter as claimed in claim 11, further comprising:
a primary power storage component, electrically connected between the second end of the primary bridge circuit and the primary coil of the transformer in series; wherein the primary power storage component stores power when charging or discharging the primary bridge circuit and the secondary bridge circuit;
wherein the primary power storage component comprises a primary capacitor having a primary capacitance;
wherein the greater the primary capacitance, the greater the size of the ZVS zone defined by the first output power and voltage gain characteristic curve of the primary bridge circuit; and
wherein the smaller the primary capacitance, the smaller the size of the ZVS zone defined by the first output power and voltage gain characteristic curve of the primary bridge circuit.

17. The bidirectional power converter as claimed in claim 11, wherein the size of the ZVS zone and the second impedance value of the secondary power storage unit are generated by a normalization algorithm; and
wherein the size of the ZVS zone is defined by the maximum output power characteristic curve, the first output power and voltage gain characteristic curve of the primary bridge circuit, and the second output power and voltage gain characteristic curve of the secondary bridge circuit in a charging mode and a discharging mode of the primary bridge circuit, the secondary bridge circuit, and the primary power storage unit.

18. The bidirectional power converter as claimed in claim 17, wherein a size of a restored ZVS zone is generated by restoring the maximum output power characteristic curve, the first output power and voltage gain characteristic curve of the primary bridge circuit, the second output power and voltage gain characteristic curve of the secondary bridge circuit, and the second impedance value of the secondary power storage unit with the normalization algorithm; and
wherein the size of the restored ZVS zone is defined by a charging power and output voltage characteristic curve in the charging mode and a discharging power and output voltage characteristic curve in the discharging mode of the primary bridge circuit, the secondary bridge circuit, and the secondary power storage unit.

19. The bidirectional power converter as claimed in claim 17, wherein the size of the ZVS zone and the second impedance value of the secondary power storage unit are generated by the normalization algorithm according to a component error factor of at least one of the primary bridge circuit, the secondary bridge circuit, the secondary power storage unit, the secondary power storage element, and the transformer; and
wherein the size of the ZVS zone is defined by the maximum output power characteristic curve, the first output power and voltage gain characteristic curve of the primary bridge circuit, and the second output power and voltage gain characteristic curve of the secondary bridge circuit in the charging mode and the discharging mode of the primary bridge circuit, the secondary bridge circuit, and the secondary power storage unit.

20. The bidirectional power converter as claimed in claim 19, wherein the size of the ZVS zone and the second impedance value of the secondary power storage unit are generated by the normalization algorithm according to a safety factor; and
wherein the size of the ZVS zone is defined by the maximum output power characteristic curve, the first output power and voltage gain characteristic curve of the primary bridge circuit, and the second output power and voltage gain characteristic curve of the secondary bridge circuit in the charging mode and the discharging mode of the primary bridge circuit, the secondary bridge circuit, and the secondary power storage unit is generated further.
